(19) United States
(12) Patent Application Publication
(10) Pub. No.: US 2025/0303722 A1
(43) Pub. Date: Oct. 2, 2025

(54) LIQUID EJECTION DEVICE AND CONTROL METHOD FOR LIQUID EJECTION DEVICE

(71) Applicant: SEIKO EPSON CORPORATION, Tokyo (JP)

(72) Inventors: Kazuyoshi OHASHI, MATSUMOTO-SHI (JP); Shintaro KOMURO, MATSUMOTO-SHI (JP); Kohei UENO, SHIOJIRI-SHI (JP)

(21) Appl. No.: 19/087,740

(22) Filed: Mar. 24, 2025

(30) Foreign Application Priority Data
Mar. 27, 2024 (JP) 2024-051386
Mar. 27, 2024 (JP) 2024-051526
Mar. 27, 2024 (JP) 2024-051647

(51) Int. Cl. B41J 2/165; B41J 2/045; B41J 2/175

(52) U.S. Cl. CPC B41J 2/16552; B41J 2/04581; B41J 2/1752

(57) ABSTRACT

A liquid ejection device includes a liquid ejection section configured to eject liquid onto a medium, a mount section on which is mounted a liquid container containing the liquid ejected from the liquid ejection section, and a flow path through which the liquid contained in the liquid container flows until the liquid is ejected from the liquid ejection section, wherein the mount section is configured to alternatively mount a recording liquid container as a liquid container containing a recording liquid for performing recording on the medium and a processing liquid container as a liquid container containing a processing liquid for performing processing on the medium and the flow path is cleanable.

The present application is based on, and claims priority from JP Application Serial Number 2024-051526, filed Mar. 27, 2024, from JP Application Serial Number 2024-051386, filed Mar. 27, 2024, and from JP Application Serial Number 2024-051647, filed Mar. 27, 2024, the disclosures of which are hereby incorporated by reference herein in their entirety.

### BACKGROUND

### 1. Technical Field

The present disclosure relates to a liquid ejection device that ejects liquid onto a medium. The present disclosure also relates to a control method for a liquid ejection device.

### 2. Related Art

An inkjet recording device described in JP-A-2019-188699 has a liquid supply section for supplying liquid to a transported paper sheet. The liquid supplied by the liquid supply section includes colored ink and pre-processing liquid that is supplied onto the paper sheet before the colored ink is supplied.

Accordingly, the liquid supply section has a head section for ejecting the colored ink and a head section for ejecting the pre-processing liquid. The pre-processing liquid is a white ink. The head section that ejects the pre-processing liquid is disposed adjacent and upstream of the head section that ejects the colored ink in a paper sheet transport direction.

In the inkjet recording device described in JP-A-2019-188699, since the head section that ejects the pre-processing liquid is disposed adjacent to the head section that ejects the colored ink upstream in the paper sheet transport direction, the pre-processing liquid and the colored ink may mix, which may cause a defect. As a defect, in the case of the inkjet recording device described in the above described JP-A-2019-188699, color development failure is considered. As the above described defects, clogging of nozzles, for example, due to thickening of the liquid may be mentioned depending on the properties of the pre-processing liquid.

Note that such a problem occurs not only when the pre-processing liquid is ejected but also when the post-processing liquid is ejected, the pre-processing liquid will be described below as an example of the processing liquid.

The problem of mixing the pre-processing liquid and the colored ink may also occur when the head section that ejects the pre-processing liquid is disposed adjacent to the head section that ejects the colored ink downstream in the paper sheet transport direction.

The above described problem can be solved by separately configuring a device for ejecting the colored ink and a device for ejecting the pre-processing liquid and connecting the two devices. However, since the device for ejecting the pre-processing liquid has no use other than ejecting the pre-processing liquid, it is not convenient for the user.

### SUMMARY

To solve the above problem, the liquid ejection device of the present disclosure includes a liquid ejection section configured to eject liquid onto a medium; a mount section on which is mounted a liquid container containing the liquid ejected from the liquid ejection section; and a flow path through which the liquid contained in the liquid container flows until the liquid is ejected from the liquid ejection section, wherein the mount section is configured to alternatively have mounted thereon, as the liquid container, a recording liquid container containing a recording liquid for performing recording on the medium, and as the liquid container, a processing liquid container containing a processing liquid for performing processing on the medium and the flow path is cleanable.

A control method for a liquid ejection device of the present disclosure includes a liquid ejection section configured to eject liquid onto a medium, a mount section on which is mounted a liquid container containing the liquid ejected from the liquid ejection section, and a flow path through which the liquid contained in the liquid container flows until the liquid is ejected from the liquid ejection section, wherein the mount section of the liquid ejection device is configured to selectively have mounted thereon a recording liquid container as the liquid container containing a recording liquid for performing recording on the medium, a processing liquid container as the liquid container containing a processing liquid for performing processing on the medium, and a cleaning liquid container as the liquid container containing a cleaning liquid for performing cleaning of the flow path, the control method comprising: executing a recording mode in which recording is performed on the medium by ejecting the recording liquid from the liquid ejection section onto the medium executing a processing mode in which processing is performed on the medium by ejecting the processing liquid from the liquid ejection section onto the medium, and executing a cleaning mode in which the flow path through which the recording liquid and the processing liquid flow are cleaned by the cleaning liquid.

### BRIEF DESCRIPTION OF THE DRAWINGS

FIG. 1 is a diagram showing a medium transport path of the liquid ejection device.

FIG. 2 is a block diagram showing a control system of the liquid ejection device.

FIG. 3 is a diagram schematically showing a flow path of liquid.

FIG. 4 is a diagram showing a medium transport path of the liquid ejection system.

FIG. 5 is a diagram showing an example of a region for ejecting the pre-processing liquid and a recording region.

FIG. 6 is a diagram showing the medium transport path of the liquid ejection system.

FIG. 7 is a diagram showing the medium transport path of the liquid ejection system.

FIG. 8 is a diagram showing the medium transport path of the liquid ejection system.

FIG. 9 is a diagram showing the medium transport path of the liquid ejection system.

FIG. 10 is a flowchart showing a flow of processing in the liquid ejection system.

FIG. 11 is a flowchart showing control related to mounting of a liquid container on a mount section.

FIG. 12 is a flowchart showing a flow of a mode setting process.

FIG. 13 is a flowchart showing a flow of a cleaning process.

FIG. 14 is a flowchart showing a flow of a cartridge determination process.

FIG. 15 is a table showing the relationship between liquid containers contained in each of accommodation sections and liquid ejection modes.

FIG. 16 is a diagram schematically showing the flow path of the liquid.

FIG. 17A is a diagram showing a first embodiment of a mechanism for suppressing erroneous mounting of a cartridge.

FIG. 17B is a diagram showing the first embodiment of the mechanism for suppressing the erroneous mounting of the cartridge.

FIG. 17C is a diagram showing the first embodiment of the mechanism for suppressing the erroneous mounting of the cartridge.

FIG. 18 is a diagram showing a modification of a state forming section.

FIG. 19A is a diagram showing a modification of a first limiting section and an ink fitting section.

FIG. 19B is a diagram showing a modification of the first limiting section and the ink fitting section.

FIG. 19C is a diagram showing a modification of the first limiting section and the ink fitting section.

FIG. 19D is a diagram showing a modification of the first limiting section and the ink fitting section.

FIG. 20 is a diagram showing a second embodiment of a mechanism for suppressing the erroneous mounting of the cartridge.

FIG. 21 is a diagram showing the second embodiment of the mechanism for suppressing the erroneous mounting of the cartridge.

FIG. 22A is a diagram showing when the mount section is in a recording liquid state.

FIG. 22B is a diagram showing when the mount section is in a processing liquid state.

FIG. 22C is a diagram showing when the mount section is in a cleaning liquid state.

FIG. 23 is a diagram showing a modification of a cleaning liquid cartridge.

FIG. 24 is a diagram showing a modification of the second embodiment of a mechanism for suppressing the erroneous mounting of the cartridge.

FIG. 25 is a diagram showing a modification of a pre-processing liquid cartridge.

FIG. 26 is a diagram showing a modification of the cleaning liquid cartridge.

FIG. 27 is a diagram showing a modification of the second embodiment of the mechanism for suppressing the erroneous mounting of the cartridge.

FIG. 28 is a diagram showing a modification of the pre-processing liquid cartridge.

FIG. 29 is a diagram showing a modification of the cleaning liquid cartridge.

FIG. 30 is a diagram showing when the mount section is in a standby state.

FIG. 31 is a flowchart showing an example of the relationship between the control of the control section related to the mount section and user operations.

### DESCRIPTION OF EMBODIMENTS

Hereinafter, the present disclosure will be generally described.

A liquid ejection device according to a first aspect includes a liquid ejection section configured to eject liquid onto a medium; a mount section on which is mounted a liquid container containing the liquid ejected from the liquid ejection section; and a flow path through which the liquid contained in the liquid container flows until the liquid is ejected from the liquid ejection section, wherein the mount section is configured to alternatively have mounted thereon, as the liquid container, a recording liquid container containing a recording liquid for performing recording on the medium, and as the liquid container, a processing liquid container containing a processing liquid for performing processing on the medium and the flow path is cleanable.

According to the present aspect, since the recording liquid container containing the recording liquid for performing recording on the medium and the processing liquid container containing the processing liquid for performing processing on the medium can be alternatively mounted on the mount section, it is possible to eject the recording liquid and the processing liquid onto the medium by one liquid ejection device. Accordingly, a dedicated liquid ejection device for ejecting the processing liquid is not required, and the use modes of the two liquid ejection devices are increased, thereby improving the usability for the user.

Since the flow path is cleanable, if the flow path is cleaned, it is possible to suppress different types of liquids from being mixed and a good result is obtained.

A second aspect is an aspect dependent on the first aspect, wherein the mount section is configured to have mounted thereon, as the liquid container, a cleaning liquid container containing a cleaning liquid for performing cleaning of the flow path.

According to the present aspect, since the mount section is configured to have mounted thereon the cleaning liquid container containing a cleaning liquid for performing cleaning of the flow path, it is possible to easily clean the flow path by mounting the cleaning liquid container. If the flow path is cleaned, it is possible to suppress different types of liquids from being mixed and a good result is obtained.

A third aspect is an aspect dependent on the second aspect, further includes a control section configured to control the device, wherein the control section is configured to switch between a recording mode that is a mode when recording is performed on the medium with the recording liquid and a processing mode that is a mode when processing is performed on the medium with the processing liquid, and a cleaning mode that is a mode when cleaning is performed on the flow path with the cleaning liquid.

According to the present aspect, appropriate recording, processing, and cleaning can be performed in each mode.

A fourth aspect is an aspect dependent on the third aspect, wherein when switching from either the recording mode or the processing mode to an other mode, the control section causes interposition of cleaning of the flow path by the cleaning mode.

According to the present aspect, when switching from either the recording mode or the processing mode to the other mode, the control section causes interposition of cleaning of the flow path by the cleaning mode, so that it is possible to suppress mixing of the recording liquid and the processing liquid and a good result is obtained.

A fifth aspect is an aspect dependent on the fourth aspect, wherein the control section detects switching from either the recording mode or the processing mode to the other based on received job data and causes interposition of cleaning of the flow path in the cleaning mode.

According to the present aspect, the control section detects switching from either the recording mode or the processing mode to the other based on received job data and causes interposition of cleaning of the flow path in the cleaning mode, it is possible to handle with a case where the user transmits the job data without being aware of the current mode.

A sixth aspect is an aspect dependent on the fourth aspect, wherein the control section detects mounting of the liquid container on the mount section, detects switching from either the recording mode or the processing mode to the other based on the detection, and causes interposition of cleaning of the flow path in the cleaning mode.

According to the present aspect, since the control section detects mounting of the liquid container on the mount section, detects switching from either the recording mode or the processing mode to the other based on the detection, and causes interposition of cleaning of the flow path in the cleaning mode, usability is improved compared to a case where the user causes the cleaning mode to be executed by the user self.

Note that the present aspect is not limited to the fourth aspect and may be dependent on the fifth aspect.

A seventh aspect is an aspect dependent on the fourth aspect, wherein the control section detects switching from either the recording mode or the processing mode to the other based on an input from an operation section that receives an operation setting and causes interposition of cleaning of the flow path in the cleaning mode.

According to the present aspect, since the control section detects switching from either the recording mode or the processing mode to the other based on an input from an operation section that receives an operation setting and causes interposition of cleaning of the flow path in the cleaning mode, usability is improved compared to a case where a user causes the cleaning mode to be executed by the user self.

Note that the present aspect is not limited to the fourth aspect and may be dependent on the fifth or sixth aspect.

An eighth aspect is an aspect dependent on the third aspect, wherein the recording liquid container, the processing liquid container, and the cleaning liquid container each have an information holding section that holds liquid information and that is accessible by the control section and when power of the device is turned on, the control section accesses the information holding section and issues an alert when, compared to the liquid information when the information holding section was last accessed, one of the recording liquid container or the processing liquid container was replaced with the other.

When the power of the device is turned off or the device is shifted to the power saving mode, there is a possibility that the user replaces either the recording liquid container or the processing liquid container with the other. In this case, if the liquid is caused to flow from the mount section to the liquid ejection section as is, the recording liquid and the processing liquid are mixed with each other, which may cause a defect.

According to the present aspect, when the power is turned on, the control section accesses the information holding section, and generates an alert when one of the recording liquid container and the processing liquid container is replaced with the other in comparison with the liquid information when the information holding section was last accessed, it is possible to suppress mixing of the recording liquid and the processing liquid and a good result is obtained.

Note that the present aspect is not limited to the third aspect and may be dependent on any of the fourth to seventh aspects.

A ninth aspect is an aspect dependent on the third aspect, further includes a maintenance section configured to perform maintenance of the liquid ejection section, wherein the cleaning mode is a mode for cleaning the flow path by performing maintenance using the cleaning liquid and the maintenance section.

According to the present aspect, since the cleaning mode is a mode for cleaning the flow path by performing the maintenance using the cleaning liquid and the maintenance section, it is possible to clean the flow path with easy workability. At the same time, the maintenance section can also be cleaned.

Note that the present aspect is not limited to the third aspect and may be dependent on any of the fourth to eight aspects.

A tenth aspect is an aspect dependent on the ninth aspect, further includes a waste liquid storage section configured to store waste liquid generated by the maintenance section, wherein the cleaning liquid used in the cleaning mode is discharged to the waste liquid storage section.

According to the present aspect, since the cleaning liquid used in the cleaning mode is discharged to the waste liquid storage section, the cleaning liquid that has finished cleaning the flow path is also discharged to the waste liquid storage section in addition to the recording liquid. Accordingly, it is not necessary to prepare a dedicated waste liquid storage section when the flow path is cleaned, and usability is improved.

An eleventh aspect is an aspect dependent on the third aspect, wherein during either the recording mode or the processing mode while cleaning in the cleaning mode is not completed, the control section restricts the liquid container to be used in the other mode from being mounted on the mount section.

According to the present aspect, when either the recording mode or the processing mode is in operation and cleaning in the cleaning mode is not completed in one mode either the recording mode or the processing mode, the control section restricts the liquid container to be used in the other mode from being mounted on the mount section, so that it is possible to suppress mixing of the recording liquid and the processing liquid.

Note that the present aspect is not limited to the third aspect and may be dependent on any of the fourth to tenth aspects.

A twelfth aspect is an aspect dependent on the third aspect, wherein the mount section is configured to have mounted thereon a first recording liquid container configured to contain recording liquid of a first color and a second recording liquid container configured to contain recording liquid of a second color different from the first color.

According to the present aspect, the operation and effect of the third aspect can be obtained in a liquid ejection device capable of recording with the recording liquids of different colors.

A thirteenth aspect is an aspect dependent on the twelfth aspect, wherein the mount section includes a first mount region on which the first recording liquid container is mounted and a second mount region on which the second recording liquid container is mounted and when the processing liquid container is mounted on either the first mount region or the second mount region and when the recording liquid container is mounted on the other of the first mount region and the second mount region, the control section performs an error process.

According to the present aspect, when the processing liquid container is mounted on either the first mount region or the second mount region and when the recording liquid container is mounted on the other of the first mount region and the second mount region, the control section performs an error process, so that it is possible to suppress the recording liquid and the processing liquid from being mixed after being ejected.

A fourteenth aspect is an aspect dependent on the twelfth aspect, wherein the mount section includes a first mount region on which the first recording liquid container is mounted and a second mount region on which the second recording liquid container is mounted and when the processing mode is executed in a state where the processing liquid container is mounted on the first mount region and the cleaning liquid container is mounted on the second mount region, the control section converts image data included in the job data into data of the first color.

In the case of the processing mode is executed in a state where the processing liquid container is mounted on the first mount region and the cleaning liquid container is mounted on the second mount region, if the image data includes the first color and the second color, when attempting to apply the processing liquid onto the medium using the image data, the processing liquid will not be applied to an image area formed by the second color unless some processing is performed.

However, according to the present aspect, when the processing mode is executed in a state where the processing liquid container is mounted on the first mount region and the cleaning liquid container is mounted on the second mount region, the control section converts image data included in the job data into data of the first color, so that even if the processing liquid container is not mounted on both the first mount region and the second mount region, the processing liquid can be appropriately ejected to the image area.

Note that the present aspect is not limited to the twelfth aspect and may be dependent on the thirteenth aspect.

A fifteenth aspect is an aspect dependent on the twelfth aspect, wherein the mount section includes a first mount region on which the first recording liquid container is mounted and a second mount region on which the second recording liquid container is mounted and the first mount region and the second mount region are configured to have mounted thereon the processing liquid container and the cleaning liquid container.

According to the present aspect, since the first mount region and the second mount region are configured to mount the processing liquid container and the cleaning liquid container, a plurality of processing liquid containers can be used, and it is possible to improve throughput when the processing liquid is ejected onto the medium.

Note that the present aspect is not limited to the twelfth aspect and may be dependent on the thirteenth or fourteenth aspect.

A sixteenth aspect is an aspect dependent on the first aspect, wherein the liquid ejection section includes nozzles configured to eject the liquid onto the medium over an entire width direction, which intersects a transport direction of the medium.

According to the present aspect, in a configuration in which the liquid ejection section includes nozzles configured to eject the liquid onto the medium over an entire width direction, which intersects a transport direction of the medium, the operation and effect of the first aspect described above can be obtained.

A control method for a liquid ejection device according to seventeenth aspect, wherein the liquid ejection device including a liquid ejection section configured to eject liquid onto a medium, a mount section on which is mounted a liquid container containing the liquid ejected from the liquid ejection section, and a flow path through which the liquid contained in the liquid container flows until the liquid is ejected from the liquid ejection section, wherein the mount section of the liquid ejection device is configured to selectively have mounted thereon a recording liquid container as the liquid container containing a recording liquid for performing recording on the medium, a processing liquid container as the liquid container containing a processing liquid for performing processing on the medium, and a cleaning liquid container as the liquid container containing a cleaning liquid for performing cleaning of the flow path, the control method comprising: executing a recording mode that is a mode in which recording is performed on the medium by ejecting the recording liquid from the liquid ejection section onto the medium, executing a processing mode that is a mode in which processing is performed on the medium by ejecting the processing liquid from the liquid ejection section onto the medium, and executing a cleaning mode that is a mode in which the flow path through which the recording liquid and the processing liquid flow are cleaned using the cleaning liquid.

According to the present aspect, since the mount section of the liquid ejection device is configured to selectively mount a first liquid container containing the recording liquid for performing recording on the medium and a second liquid container containing the processing liquid for performing processing on the medium, it is possible to eject the recording liquid and the processing liquid onto the medium by one liquid ejection device. Accordingly, a dedicated liquid ejection device for ejecting the processing liquid is not required, and the use modes of the two liquid ejection devices are increased, thereby improving the usability for the user.

Since the flow path is cleanable, if the flow path is cleaned, it is possible to suppress different types of liquids from being mixed and a good result is obtained.

Since the mount section is configured to mount a cleaning liquid container contains a cleaning liquid for performing cleaning of the flow path, it is possible to easily clean the flow path by mounting the cleaning liquid container. If the flow path is cleaned, it is possible to suppress different types of liquids from being mixed and a good result is obtained. By switching the mode, appropriate recording, processing, and cleaning can be performed.

An eighteenth aspect is an aspect dependent on the seventeenth aspect, wherein the mount section includes a first mount region on which a first recording liquid container storing recording liquid of a first color is mounted and a second mount region on which a second recording liquid container storing recording liquid of a second color different from the first color is mounted, the control method comprising: determining type of the liquid container mounted on the first mount region and the second mount region and prompting mounting of the cleaning liquid container or the processing liquid container on the second mount region when a current mode is the processing mode, the processing liquid container is mounted on the first mount region, and the recording liquid container is mounted on the second mount region.

According to the present aspect, it is possible to suppress mixing of the recording liquid and the processing liquid.

Hereinafter, the present disclosure will be described in detail.

An X-Y-Z coordinate system shown in each drawing is an orthogonal coordinate system, and a Y-axis direction is a direction intersecting a transport direction of a medium, that is, a medium width direction, and is a device depth direction. In the present embodiment, of the side surfaces constituting the periphery of a device main body 2 of a liquid ejection device 1, a side surface in a +Y direction is a rear surface, and a side surface in a −Y direction is a front surface.

An X-axis direction is a device width direction and as viewed from an operator of the liquid ejection device 1, a +X direction is a left side and a −X direction is a right side. The −X direction is a medium feeding direction from each medium cassette (to be described later). The +X direction is a transport direction of the medium at a position facing a liquid ejection section 12.

A Z-axis direction is a vertical direction, that is, a device height direction, a +Z direction is an upward direction, and a-Z direction is a downward direction.

Hereinafter, a direction in which the medium is sent may be referred to as “downstream” and an opposite direction may be referred to as “upstream”. In each drawing, a medium transport path is indicated by dashed line. In the liquid ejection device 1, the medium is transported through the medium transport path indicated by dashed line.

### Configuration of Liquid Ejection Device

In the present embodiment, the liquid ejection device 1 is an inkjet printer that performs recording by ejecting ink, which is an example of liquid, onto the medium represented by a recording paper sheet. Note that a liquid ejection system (to be described later) is a system including a plurality of liquid ejection device 1.

Note that in this specification, the terms “recording” and “printing” are used in some cases, but have the same meaning in that an image is formed on the medium by ejecting liquid onto the medium. Therefore, “recording” may be referred to as “printing” or “image formation”, and “printing” may be referred to as “recording” or “image formation”.

The liquid ejection device 1 includes a plurality of medium cassettes, specifically, a first medium cassette 3, a second medium cassette 4, a third medium cassette 5, and a fourth medium cassette 6 along the vertical direction in a lower portion of the device main body 2 including the liquid ejection section 12 (to be described later). Hereinafter, when these medium cassettes are not distinguished from each other, they are simply referred to as medium cassettes.

Each of the medium cassettes is provided with a pickup roller that sends out the accommodated medium in the −X direction. Reference symbols 21, 22, 23, and 24 indicate the pickup rollers provided for each of the medium cassettes. Note that the configuration in which the accommodated medium is in contact with the pickup roller may be a configuration in which the pickup roller moves forward and backward with respect to the medium or may be a configuration in which the medium is pushed up by an elevating plate provided in each medium cassette.

Each medium cassette is provided with a feed roller pair for feeding the medium sent out by the pickup roller further downstream. Reference symbols 25, 26, 27, and 28 indicate the feed roller pairs provided for each of the medium cassettes.

Note that in the following, the term “roller pair” is assumed to be configured of a drive roller driven by a power source such as a motor and a driven roller that is in contact with the drive roller and rotates in a driven manner, unless otherwise specifically described.

The medium sent out from the first medium cassette 3 is sent to the transport roller pair 34 by receiving the sending force from the transport roller pairs 29 and 33. The medium sent out from the second medium cassette 4 is sent to the transport roller pair 34 by receiving the sending force from the transport roller pairs 30, 29, and 33. The medium sent out from the third medium cassette 5 is sent to the transport roller pair 34 by receiving the sending force from the transport roller pairs 31, 30, 29, and 33. The medium sent out from the fourth medium cassette 6 sent to the transport roller pair 34 by receiving the sending force from the transport roller pairs 32, 31, 30, 29, and 33. Reference symbol T1 indicates the transport path of the medium sent out from the medium cassettes and reaching the transport roller pair 34.

The medium receiving the sending force from the transport roller pair 34 is sent between the liquid ejection section 12 and a transport belt 66, that is, to a liquid ejecting position facing the liquid ejection section 12. The transport roller pair 34 configures a transport section that transports the medium to between the liquid ejection section 12 and the transport belt 66.

The liquid ejection section 12 ejects the liquid onto the surface of the medium. In the present embodiment, the liquid ejection section 12 is a line head in which a plurality of nozzles 13 for ejecting the liquid is disposed over the entire region in the medium width direction. However, the liquid ejection section 12 may be an ink ejection head mounted on a carriage and ejecting liquid while moving in the medium width direction.

The liquid ejection section 12 according to the present embodiment employs a piezo clement that is a piezoelectric element whose volume changes when a voltage is applied. By controlling the drive waveform of the piezoelectric element, the movement of the meniscus of the nozzle 13 can be controlled and the size and eject speed of liquid droplet to be ejected can be controlled.

Note that in the present embodiment, the plurality of nozzles 13 includes a nozzle capable of ejecting yellow ink, a nozzle capable of ejecting magenta ink, a nozzle capable of ejecting cyan ink, and a plurality of nozzles capable of ejecting black ink. The ink of each color is an example of a recording liquid for performing recording on the medium. Note that as will be described in detail later, a cleaning liquid can be ejected from the nozzles that eject the ink of each color, and a processing liquid typified by the pre-processing liquid and a post-processing liquid can be ejected.

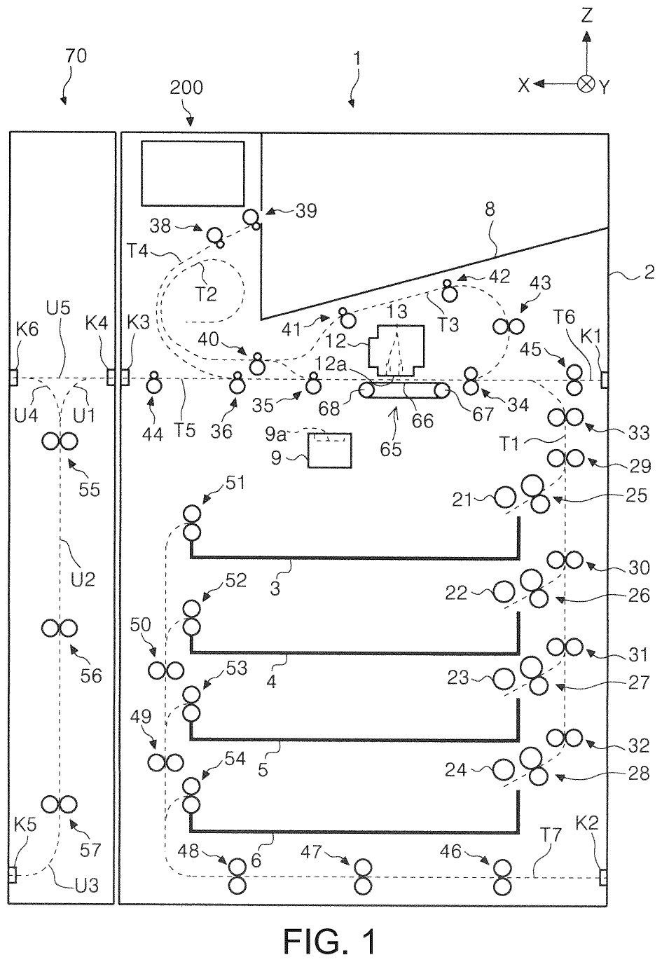

Next, the transport belt 66 is an endless belt wound around the drive roller 67 and the driven roller 68 and rotates when the drive roller 67 is driven by a motor (not shown). The medium is transported to a position facing the liquid ejection section 12 while attached to a belt surface of the transport belt 66. The drive roller 67, the driven roller 68, and the transport belt 66 constitute a belt unit 65. The belt unit 65 uses the drive roller 67 as a pivoting axis, is provided to be pivotable by a power source (not shown), and switches between a state in which the medium can be transported as shown in FIG. 1 and a position (not shown) at which the belt unit retreats from the liquid ejection section 12 by pivoting.

The medium on which the liquid is ejected by the liquid ejection section 12 is sent toward either the transport roller pair 36 or the transport roller pair 40 by the transport roller pair 35 positioned downstream the transport belt 66. Accordingly, a path switching flap (not shown) is provided in the vicinity downstream of the transport roller pair 35.

In a case where the surface of the medium is inversed and the liquid is not ejected onto the medium again, the medium is sent from the transport roller pair 35 toward the transport roller pair 36. Downstream from the transport roller pair 36, a discharge path T4 and a discharge path T5 can be selected. Accordingly, a path switching flap (not shown) is provided in the vicinity downstream of the transport roller pair 36.

When the discharge path T4 is selected, the medium is discharged to a discharge tray 8 through the discharge path T4. A transport roller pair 38 and a transport roller pair 39 are provided in the discharge path T4.

When the discharge path T5 is selected, the medium is discharged in the +X direction from the discharge section K3 of the device main body 2 through the discharge path T5. The discharge path T5 is provided with a transport roller pair 44.

In a case where an inversion section 70 (to be described later) is connected to the liquid ejection device 1, the medium discharged from the discharge section K3 enter the inversion section 70 from the receiving section K4 of the inversion section 70.

In a case where the surface of the medium is inversed and the liquid is ejected onto the medium again, the medium is sent from the transport roller pair 35 toward the transport roller pair 40 and enters a switchback path T2. Thereafter, the rotation direction of the transport roller pair 40 is switched, the medium is switched back to enter an inversion path T3, and is sent to the transport roller pair 34 by transport roller pairs 41, 42, and 43.

The liquid ejection device 1 is provided with receiving sections K1 and K2 for receiving the medium on the side surfaces in the −X direction. The receiving section K1 is provided at a height position corresponding to a position between the liquid ejection section 12 and the belt unit 65 in the device height direction. In the present embodiment, the height positions of the receiving section K1 and the discharge section K3 are substantially the same.

The medium received from the receiving section K1 are sent to the transport roller pair 34 by a transport roller pair 45. Reference symbol T6 indicates a transport path along which the medium received from the receiving section K1 is transported. The receiving section K1 may also serve as a feed port when medium placed on a placing section (not shown) provided on the side surface in the −X direction are fed.

The receiving section K2 is provided at a position further below the position of the fourth medium cassette 6 in the device height direction.

The medium received from the receiving section K2 is carried into the first medium cassette 3, the second medium cassette 4, the third medium cassette 5, and the fourth medium cassette 6 by a carry-in path T7. More specifically, transport roller pairs 46, 47, and 48 are provided on the lower side of the fourth medium cassette 6 in the carry-in path T7, and the medium is transported in the +X direction by receiving sending forces from these transport roller pairs and are further transported in the upward direction.

A transport roller pair 54 is provided in the +X direction with respect to the fourth medium cassette 6. A path switching flap (not shown) is provided upstream of the transport roller pair 54, and the medium is transported to either the transport roller pair 54 or a transport roller pair 49. When the medium is transported to the transport roller pair 54, a sending force in the −X direction is applied to the medium by the transport roller pair 54, and the medium is carried into the fourth medium cassette 6.

A transport roller pair 53 is provided in the +X direction with respect to the third medium cassette 5. A path switching flap (not shown) is provided downstream of the transport roller pair 49, and the medium is transported to either the transport roller pair 53 or a transport roller pair 50. When the medium is transported to the transport roller pair 53, a sending forth in the −X direction is applied to the medium by the transport roller pair 53, and the medium is carried into the third medium cassette 5.

A transport roller pair 52 is provided in the +X direction with respect to the second medium cassette 4. A path switching flap (not shown) is provided downstream of the transport roller pair 50, and the medium is transported to either the transport roller pair 52 or a transport roller pair 51. When the medium is transported to the transport roller pair 52, a feeding force in the −X direction is applied to the medium by the transport roller pair 52, and the medium is carried into the second medium cassette 4.

The transport roller pair 51 is provided in the +X direction with respect to the first medium cassette 3, when the medium is transported to the transport roller pair 51, a feeding force in the −X direction is applied to the medium by the transport roller pair 51, and the medium is carried into the first medium cassette 3.

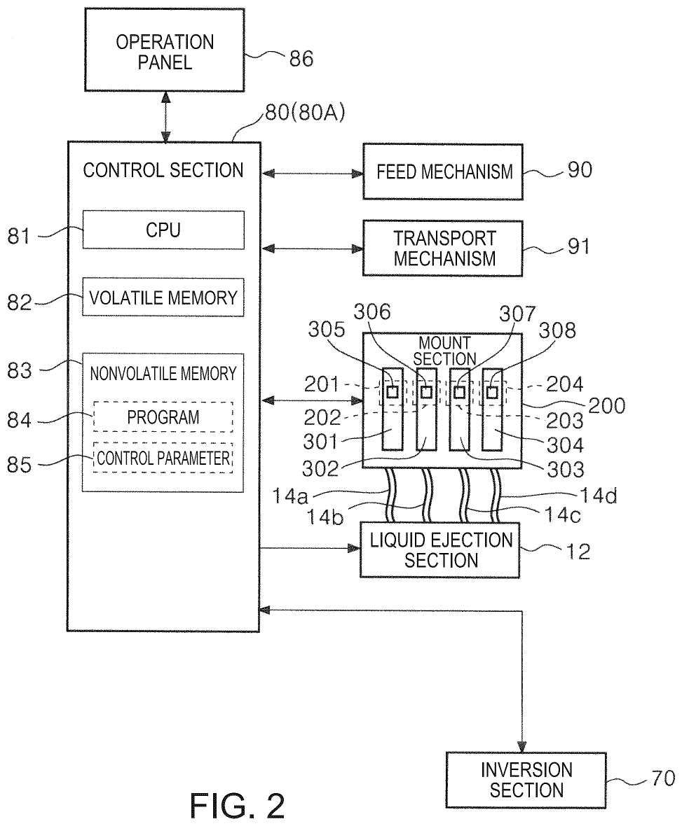

Next, reference symbol 200 indicates a mount section on which the liquid container (to be described later) containing the liquid ejected from the liquid ejection section 12 is mounted. The liquid ejected from the liquid ejection section 12 is supplied from the mount section 200 to the liquid ejection section 12 through tubes 14a, 14b, 14c, and 14d (see FIG. 2).

Reference symbol 9 indicates a cap unit having a cap 9a for capping the liquid ejection section 12. The cap unit 9 is provided so as to be displaced by a power source (not shown) between a separation position (see FIG. 1) at which the cap 9a is separated from the liquid ejection section 12 and a cap position (not shown) at which the cap 9a caps the head surface 12a of the liquid ejection section 12.

Next, the inversion section 70 will be described. The inversion section 70 is configured as a separate device from the liquid ejection device 1 in the present embodiment, it can be mechanically and electrically connected to the liquid ejection device 1, and it can be controlled by the control section 80 of the liquid ejection device 1 (to be described later). However, the inversion section 70 has an arbitrary configuration, it is not necessary to provide the inversion section 70 when only one liquid ejection device 1 is used, and it may not be necessary in the liquid ejection system to be described later.

Note that in FIG. 1, for convenience of description, the inversion section 70 is disposed in the +X direction with respect to the liquid ejection device 1. However, as will be described later, since the inversion section 70 is disposed between the two liquid ejection devices 1, it can be said that the inversion section 70 may be positioned in the −X direction as viewed from the specific liquid ejection device 1.

The inversion section 70 includes the receiving section K4 that receives the medium on a side surface in the −X direction. The position of the receiving section K4 is the same as the position of the discharge section K3 in the device height direction is the and the medium discharged from the discharge section K3 can be received by the receiving section K4.

The medium transport path downstream from the receiving section K4 branches into a skip path U5 and a switchback carry-in path U1. Therefore, a path switching flap (not shown) is provided in the vicinity downstream of the receiving section K4.

The inversion section 70 includes a discharge section K6 that discharges the medium in the +X direction on a side surface in the +X direction. In the present embodiment, the position of the discharge section K6 is the same as a position of the receiving section K4 in the device height direction. Therefore, when the skip path U5 is selected, the medium reaches the discharge section K6 straight along the X-axis direction from the receiving section K4 through the skip path U5 and is discharged in the +X direction from the discharge section K6.

When the switchback carry-in path U1 is selected, the medium enters a switchback path U2 extending along the vertical direction. Transport roller pairs 55, 56, and 57 are provided in the switchback path U2. The medium sent into the switchback path U2 receives a sending force from the transport roller pairs 55 and 56 and further from the transport roller pair 57 in some cases and is transported downward. When the trailing edge of the medium passes through the branching position between the switchback carry-in path U1 and the switchback discharge path U4, the rotation directions of the transport roller pairs 55, 56, and 57 are switched and the medium is transported upward. Then, the sheet is discharged in the +X direction from the discharge section K6 through the switchback discharge path U4. Therefore, a path switching flap (not shown) or a path guide structure (not shown) is provided in the vicinity of the upper portion of the transport roller pair 55.

Note that a discharge section K5 is provided further below the switchback path U2. The inversion section 70 can discharge the medium sent in from the switchback carry-in path U1 to the switchback path U2 in the +X direction from the discharge section K5 without switching back the medium.

The configuration of the liquid ejection device 1 and the inversion section 70 have been described above and the control section 80 will be described below with reference to FIG. 2.

The control section 80 performs various kinds of control in the liquid ejection device 1 and the liquid ejection system (to be described later). Note that in FIG. 2 mainly shows a configuration necessary for the following description, and other configurations are omitted.

The control section 80 controls a feed mechanism 90, a transport mechanism 91, the liquid ejection section 12, and the mount section 200. The control section 80 controls the inversion section 70 connected to the liquid ejection device 1.

The feed mechanism 90 includes the above described pickup rollers 21, 22, 23, and 24, feed roller pairs 25, 26, 27, and 28, and motor (not shown) that drives these rollers.

The transport mechanism 91 includes the transport roller pairs 29 to 54 described above, a motor (not shown) that drives these rollers, the plurality of path switching flaps that switches the destination of the medium described above, and a drive source (not shown) such as a solenoid that drives these path switching flaps.

Note that the motor (not shown) constituting the feed mechanism 90 and the motor (not shown) constituting the transport mechanism 91 are, for example, DC motors. Each of the motors is provided with a rotary encoder (not shown), and the control section 80 can detect rotation direction, rotation amount, and rotation speed of each of the motors by the rotary encoder. That is, the control section 80 can detect driving direction, driving amount, and driving speed of each roller described above.

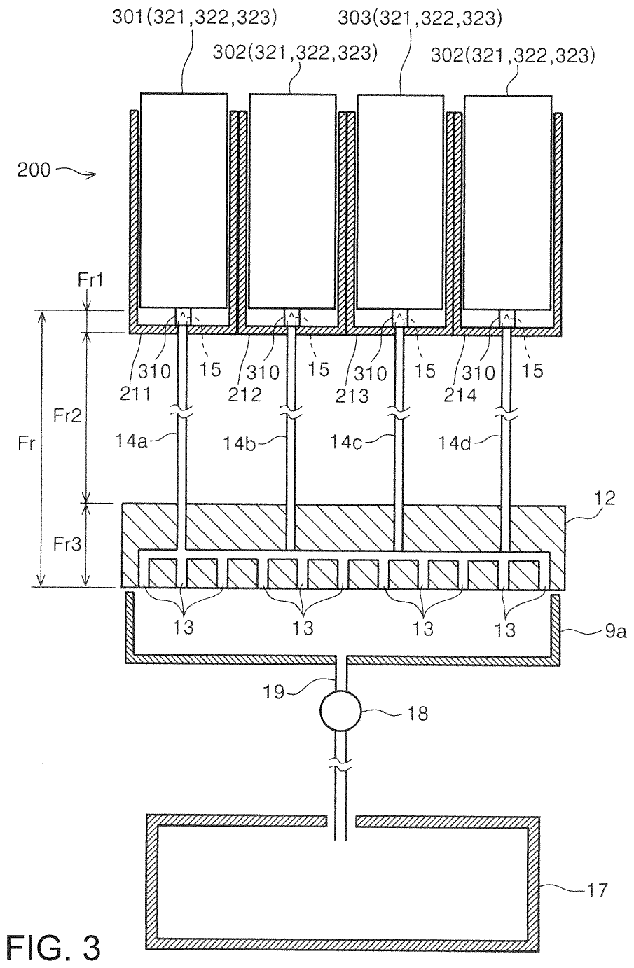

The liquid container, which contains the liquid ejected from the liquid ejection section 12, can be mounted on the mount section 200. Although the mounting of the liquid container on the mount section 200 will be described in detail later, the type of the liquid includes at least the recording liquid for performing recording on the medium and the processing liquid for performing processing on the medium. The type of liquid further includes the cleaning liquid for performing cleaning of the flow path Fr (see FIG. 3) through which the liquid contained in the liquid container flows until the liquid is ejected from the liquid ejection section 12.

An ink containing a coloring material is an example of the recording liquid. Examples of the processing liquid include the pre-processing liquid and the post-processing liquid. Hereinafter, the liquid container containing the ink will be referred to as an “ink cartridge” in the present embodiment. The liquid container containing the processing liquid will be referred to as a “processing liquid cartridge” in the present embodiment. The processing liquid cartridge may be a “pre-processing liquid cartridge” containing the pre-processing liquid or a “post-processing liquid cartridge” containing the post-processing liquid. The liquid container containing the cleaning liquid will be referred to as a “cleaning liquid cartridge” in the present embodiment. In a case where the cartridges are not distinguished from each other, the cartridges may be simply referred to as “cartridge”. The term “liquid container” may be used instead of the term “cartridge”.

The ink cartridge is an example of a recording liquid container containing the recording liquid. The processing liquid cartridge is an example of a processing liquid container containing the processing liquid for performing processing on the medium. The cleaning liquid cartridge is an example of a cleaning liquid container containing the cleaning liquid for performing cleaning of the flow path Fr (see FIG. 3).

Here, the flow path Fr will be described with reference to FIG. 3. FIG. 3 schematically shows the liquid flow path, and the flow path Fr includes a flow path Fr1, which is a section in the mount section 200, a flow path Fr2, which is a section formed by the tubes 14a, 14b, 14c, and 14d connecting the mount section 200 and the liquid ejection section 12, and a flow path Fr3, which is a section in the liquid ejection section 12 including the nozzles 13. Note that hereinafter, when the tubes 14a, 14b, 14c, and 14d are not distinguished from each other, they are collectively referred to as tube 14.

The flow path Fr can be cleaned by ejecting the cleaning liquid from the nozzles 13 in a state where the cleaning liquid cartridge is mounted on the mount section 200.

Note that the mount section 200 according to the present embodiment includes a first accommodation section 211, a second accommodation section 212, a third accommodation section 213, and a fourth accommodation section 214 for accommodating the cartridges. That is, the plurality of cartridges can be attached to and detached from the mount section 200 according to the present embodiment.

A liquid supply needle 15 is provided at the bottom of each accommodation section. The liquid supply needle 15 is provided on one end side of the tube 14. The cartridge is provided with a liquid supply section 310, and when each cartridge is mounted on each cartridge accommodation section, the liquid supply needle 15 enters the liquid supply section 310 and the liquid can be supplied from the cartridge.

One end of a tube 19 is connected to the cap 9a, which caps the liquid ejection section 12. The other end of the tube 19 enters a waste liquid storage section 17, whereby the liquid ejected to the cap 9a is collected by the waste liquid storage section 17. Reference symbol 18 indicates a pump for generating a negative pressure in the cap 9a. By operating the pump 18 in a state of the cap 9a capping the liquid ejection section 12, the liquid is sucked from the nozzles 13.

The cap 9a is an example of a maintenance section for performing maintenance of the liquid ejection section 12.

As described above, in the liquid ejection device 1, since the flow path Fr can be cleaned, if the flow path Fr is cleaned, it is possible to suppress different types of liquids from being mixed and a good result is obtained.

In the present embodiment, since the cleaning liquid cartridge containing the cleaning liquid for cleaning the flow path Fr can be mounted on the mount section 200, the flow path Fr can be easily cleaned. If the flow path Fr is cleaned, it is possible to suppress different types of the liquid from being mixed and a good result is obtained.

In FIG. 2 and FIG. 3, the ink cartridge is mounted as an example. Specifically, an ink cartridge 301 containing black ink is mounted on the first accommodation section 211, an ink cartridge 302 containing magenta ink is mounted on the second accommodation section 212, an ink cartridge 303 containing cyan ink is mounted on the third accommodation section 213, and an ink cartridge 304 containing yellow ink is mounted on the fourth accommodation section 214.

Note that in the following description, the ink cartridge may be described without using the reference symbol. Specifically, the black ink cartridge 301 may be referred to as “ink cartridge (BK)”, the magenta ink cartridge 302 may be referred to as “ink cartridge (M)”, the cyan ink cartridge 303 may be referred to as “ink cartridge (C)”, and the yellow ink cartridge 304 may be referred to as “ink cartridge (Y)”.

In FIG. 3, reference symbol 321 indicates the pre-processing liquid cartridge, reference numeral 322 indicates the post-processing liquid cartridge, and reference numeral 323 indicates the cleaning liquid cartridge.

Instead of the ink cartridge, the pre-processing liquid cartridge 321, the post-processing liquid cartridge 322, and the cleaning liquid cartridge 323 can be mounted on each of the accommodation sections.

Note that hereinafter, the pre-processing liquid cartridge 321, the post-processing liquid cartridge 322, and the cleaning liquid cartridge 323 may be described only by names without reference symbols.

As shown in FIG. 2, a cartridge IC, which is an example of an information holding section for holding information such as a type of the liquid and the remaining amount, is provided in the liquid container, that is, in each cartridge. Reference symbol 305 indicates the cartridge IC provided in the black ink cartridge 301 and the reference symbol 306 indicates the cartridge IC provided in the magenta ink cartridge 302. Reference symbol 307 indicates the cartridge IC provided in the cyan ink cartridge 303 and reference numeral 308 denotes the cartridge IC provided in the yellow ink cartridge 304. The cartridge IC of each ink cartridge holds the information such as that the liquid is ink, the ink color, and the remaining amount.

Note that the cartridge IC is also provided in the processing liquid cartridge and the cleaning liquid cartridge (to be described later). Hereinafter, the cartridge IC provided in each cartridge may be simply referred to as a cartridge IC without distinction.

The mount section 200 is provided with a contact point, which is electrically contactable with the cartridge IC. Reference symbol 201 is a contact point provided in the first accommodation section 211, reference symbol 202 is a contact point provided in the second accommodation section 212, reference symbol 203 is a contact point provided in the third accommodation section 213, reference symbol 204 is a contact point provided in the fourth accommodation section 214.

The control section 80 can detect information such as a type and the remaining amount of the liquid by reading the information of the cartridge IC. When the liquid is consumed, the control section 80 updates the remaining amount information of the cartridge IC based on the consumed amount. The control section 80 can detect that the cartridge is replaced by reading the information of the cartridge IC at a predetermined timing or at predetermined time intervals.

Next, the control section 80 includes a CPU 81 that performs execution processing of a computer program, in other words, software, a volatile memory 82, and a nonvolatile memory 83. The CPU 81 performs various operations necessary for executing the program 84 stored in the nonvolatile memory 83. The volatile memory 82 is used as a temporary data storage area. The nonvolatile memory 83 stores the program 84 and control parameters 85 necessary for executing the program 84. The program 84 includes a program for executing various processes (to be described later) and the control parameter 85 includes a parameter for executing the program 84. The various processes (to be described later) are realized by the control section 80 executing the program 84.

The control section 80 can receive various operation settings by a user from an operation panel 86 included in the liquid ejection device 1. The operation panel 86 includes a touch panel, a power button, and other setting buttons, which are not shown.

### Liquid Ejection System Configuration

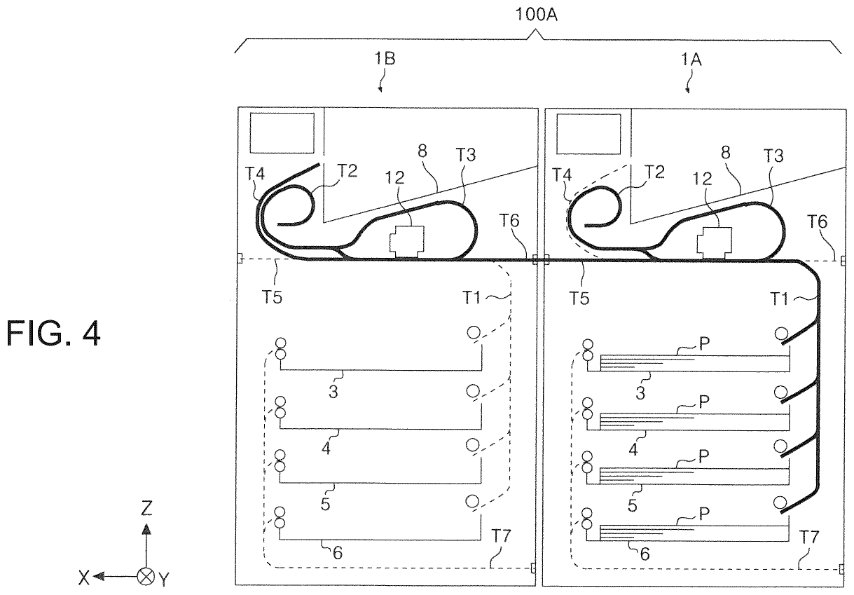

Next, a liquid ejection system using the liquid ejection device 1 will be described with reference to FIG. 4 and subsequent drawings.

First, the processing liquid and the cleaning liquid will be described below.

At least the ink cartridge and the processing liquid cartridge can be selectively mounted on the mount section 200 of the liquid ejection device 1. Furthermore, the cleaning liquid cartridge may be mountable. Therefore, the shape and size of a housing of the ink cartridge, the processing liquid cartridge, and the cleaning liquid cartridge are basically the same. However, details may be different, which will be described later.

For example, when the ink cartridge is mounted on the mount section 200, the liquid ejection device 1 can perform recording by ejecting the ink onto the medium. For example, when the processing liquid cartridge is mounted on the mount section 200, the liquid ejection device 1 can perform pre-processing or post-processing on the medium according to the type of processing liquid. For example, when the cleaning liquid cartridge is mounted on the mount section 200, the liquid ejection device 1 can perform cleaning the flow path Fr.

Note that in addition, as will be described in detail later, in a case where the plurality of cartridges can be mounted on the mount section 200, the cartridges of the ink and the cleaning liquid may be mixed, or the cartridges of the processing liquid and the cleaning liquid may be mixed. However, it is desirable to exclude a case where the cartridges of the ink and the processing liquid are mixed.

As the pre-processing liquid, those conventionally known for suppressing ink bleeding and improving recording quality by ejecting onto the medium before ink ejection can be appropriately employed, and as an example, a liquid containing pure water as a solvent and an aggregating agent such as a polyvalent metal salt can be employed. Of course, such a pre-processing liquid is an example and is not limited to this.

Note that the aggregating agent causes the coloring material to aggregate by reacting with components such as a coloring material contained in the ink and a pigment dispersion and a resin that may be contained in the ink. The aggregating agent increases the viscosity of the ink composition by reacting with the pigment dispersion and/or the resin that may be contained in the ink composition. Therefore, when the pre-processing liquid and the ink are mixed in the flow path Fr of liquid, ejection failure is caused, so that it is necessary to interpose the cleaning process when the ink cartridge is replaced with the processing liquid cartridge or when the processing liquid cartridge is replaced with the ink cartridge. Of course, even if the pre-processing liquid does not contain the aggregating agent, for example, when white ink is used as the pre-processing liquid, the desired processing results will not be obtained if the pretreatment liquid mixes with another color ink, so it is necessary to interpose the cleaning process when the ink cartridge is replaced with the processing liquid cartridge or the processing liquid cartridge is replaced with the ink cartridge.

As the post-processing liquid, it is possible to appropriately employ the post-processing liquid which is known in the related art for improving water resistance, light resistance, gas resistance, abrasion resistance, glossiness, coloring properties, and the like of the recorded image by ejecting the post-processing liquid onto the medium onto which ink has been ejected and covering the recording surface with a protective layer formed of a coating film. An example of the post-processing liquid containing a water-soluble resin or a water-soluble emulsion in pure water as a solvent, but is not limited to this. Note that as for the post-processing liquid, mixing with the ink may cause, for example, an increase in the viscosity of the ink, and therefore, it is necessary to interpose the cleaning process when the ink cartridge is replaced with the processing liquid cartridge or the processing liquid cartridge is replaced with the ink cartridge.

The cleaning liquid may be any one as long as it can clean the nozzle 13 and the flow path Fr, and as an example, one containing pure water as a main component and a surfactant, a viscosity adjusting agent, and an antifoaming agent can be employed. Of course, such a cleaning liquid is an example and is not limited to this.

Next, an example of the specific liquid ejection system will be described.

A liquid ejection system 100A shown in FIG. 4 includes a first liquid ejection device 1A and a second liquid ejection device 1B. The first liquid ejection device 1A and the second liquid ejection device 1B are the liquid ejection device 1 described with reference to FIG. 1. Note that in FIG. 4 and subsequent drawings, in order to avoid complications of the drawing, the numbers of the rollers and the reference symbols are reduced from those in FIG. 1.

The first liquid ejection device 1A and the second liquid ejection device 1B are mechanically coupled by a coupling section (not shown) and are electrically connected by a connector (not shown). As a result, the control section 80 of the first liquid ejection device 1A and the control section 80 of the second liquid ejection device 1B can communicate with each other and the first liquid ejection device 1A and the second liquid ejection device 1B can execute ejecting the liquid onto the medium in cooperation with each other.

Note that similarly, in other embodiments described below, the plurality of liquid ejection devices can communicate with each other between the control sections 80 and liquid ejection onto the medium can be performed in cooperation with each other.

Various recording settings, recording execution operations, and the like by the user may be executed by only one of the first liquid ejection device 1A and the second liquid ejection device 1B or may be executed by both.

In the liquid ejection system 100A, after the liquid is ejected from the first liquid ejection device 1A, the medium is sent to the second liquid ejection device 1B, and the liquid is ejected from the second liquid ejection device 1B.

As an example, in the present embodiment, the processing liquid cartridge is mounted on the mount section 200 included in the first liquid ejection device 1A and the ink cartridge is mounted on the mount section included in the second liquid ejection device 1B. That is, the first liquid ejection device 1A ejects the pre-processing liquid onto the medium and the second liquid ejection device 1B ejects the ink onto the medium.

However, it is not limited this, the ink may be ejected in the first liquid ejection device 1A and the post-processing liquid may be ejected in the second liquid ejection device 1B. Alternatively, the ink may be ejected by both the first liquid ejection device 1A and the second liquid ejection device 1B. Alternatively, the pre-processing liquid may be ejected by both the first liquid ejection device 1A and the second liquid ejection device 1B. The first liquid ejection device 1A and the second liquid ejection device 1B do not necessarily need to use both and a predetermined liquid may be ejected using only either the first liquid ejection device 1A or the second liquid ejection device 1B.

This is the same in other liquid ejection systems to be described below, and the liquids to be ejected in the plurality of liquid ejection devices included in the liquid ejection system can be any combination of the ink and the processing liquid as long as no technical contradiction arises.

In FIG. 4, thick solid line indicates the medium transport path when such liquid eject is performed. A medium indicated by a reference symbol P is sent out from any of the medium cassettes of the first liquid ejection device 1A, inversed after the pre-processing liquid is ejected onto a first surface, and then the pre-processing liquid is ejected onto a second surface. Then, it is sent to the second liquid ejection device 1B, it is inverse after recording is performed on the second surface, recording is performed on the first surface, and it is discharged to the discharge tray 8.

However, the discharge destination of the medium is not limited to this and the medium may be discharged from the discharge section K3 through the discharge path T5. In this case, the liquid may be discharged to a discharge tray (not shown) attached to the side surface of the second liquid ejection device 1B in the +X direction. The discharge tray (not shown) may be configured to be attachable to and detachable from the second liquid ejection device. The medium that is discharged from the discharge section K3 may be delivered to a processing device which is disposed in the +X direction of the second liquid ejection device 1B, a relay transport device that relays the medium to the processing device, or the like. The processing device may perform, for example, a stapling process, a punching process, a saddle stitching process, a folding process, a drying process, or the like.

As described above, the liquid ejection system 100A includes the first liquid ejection device 1A that ejects the liquid onto the medium, and the second liquid ejection device 1B that is a device that can receive the medium from which the liquid has been ejected by the first liquid ejection device 1A and ejects the liquid onto the medium. The first liquid ejection device 1A and the second liquid ejection device 1B are provided with the liquid ejection section 12 for ejecting the liquid onto the medium, the mount section 200 on which the liquid container containing the liquid to be ejected from the liquid ejection section 12 is mounted, and the flow path Fr of liquid Fr from the mount section 200 to the liquid ejection section 12. The ink cartridge containing the ink for performing recording on the medium and the processing liquid cartridge containing the processing liquid for performing processing on the medium can be alternatively mounted on the mount section 200. Note that this feature is the same in other liquid ejection systems (to be described later).

According to the liquid ejection system 100A as described above, it is possible to execute the ejection of the ink and the ejection of the processing liquid onto the medium by one liquid ejection device 1. Accordingly, a dedicated liquid ejection device for ejecting the processing liquid is not required, and the use modes of the two liquid ejection devices are increased, thereby improving the usability for the user.

Note that the liquid ejection system 100A connects two liquid ejection devices, three or more liquid ejection devices may be connected. For example, when three liquid ejection devices are connected, the liquid can be ejected in the order of pre-processing, recording, and post-processing.

When ejecting the processing liquid onto the medium, the control section 80 may eject the processing liquid onto the medium based on the recording data when recording on the medium with the ink. Specifically, the processing liquid may be ejected to the same region as a recording region in which recording is performed on the medium or to a region which includes the recording region and is slightly larger than the recording region. Accordingly, it is possible to suppress the use amount of the processing liquid compared to a case where the processing liquid is ejected onto the entire surface of the medium without being based on the recording data.

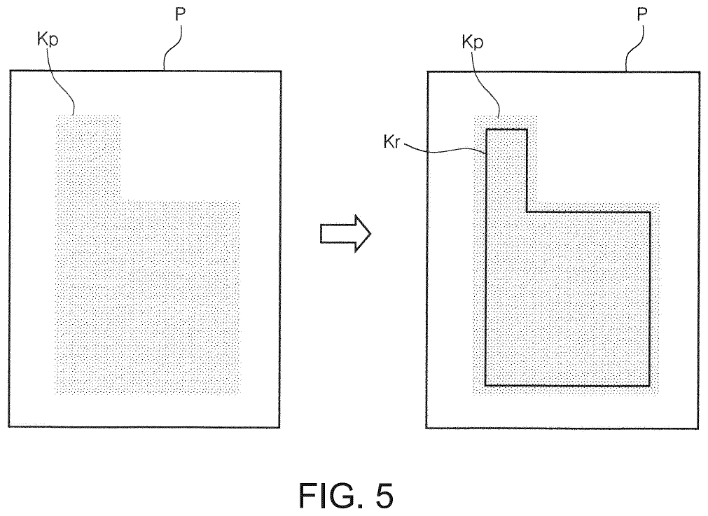

FIG. 5 shows an example of a region where the processing liquid is ejected and a recording region, and in the left drawing of FIG. 5, reference symbol Kp indicates a region where the pre-processing liquid is ejected to the medium P, and in the right drawing of FIG. 5, reference symbol Kr indicates the recording region. In this example, the pre-processing liquid is ejected to a region slightly larger than the recording region Kr, but an ejection region Kp of the pre-processing liquid may be the same as the recording region Kr. Note that the ejection region Kp may be a region where the post-processing liquid is ejected.

As described above, particularly when the liquid ejection device is an inkjet printer, the region for ejecting the processing liquid can be freely set, so that the amount of the processing liquid used can be suppressed as compared with a configuration in which the processing liquid is uniformly ejected over the entire surface of the medium.

Such a method of ejecting the processing liquid is also applicable to other liquid ejection systems (to be described later).

Note that the first liquid ejection device 1A and the second liquid ejection device 1B according to the present embodiment is configured to inverse the front and back sides of the medium recorded by the liquid ejection section 12 so as to be re-transportable to the liquid ejection section 12. Specifically, the front and back sides of the medium are inversed by the switchback path T2 and the inversion path T3. Accordingly, the liquid can be ejected to both surfaces of the medium.

The first liquid ejection device 1A and the second liquid ejection device 1B according to the present embodiment have the same device configuration. Accordingly, it improves the usability of the user as compared with the case where the first liquid ejection device 1A and the second liquid ejection device 1B have different device configurations.

However, the first liquid ejection device 1A and the second liquid ejection device 1B may have different device configurations.

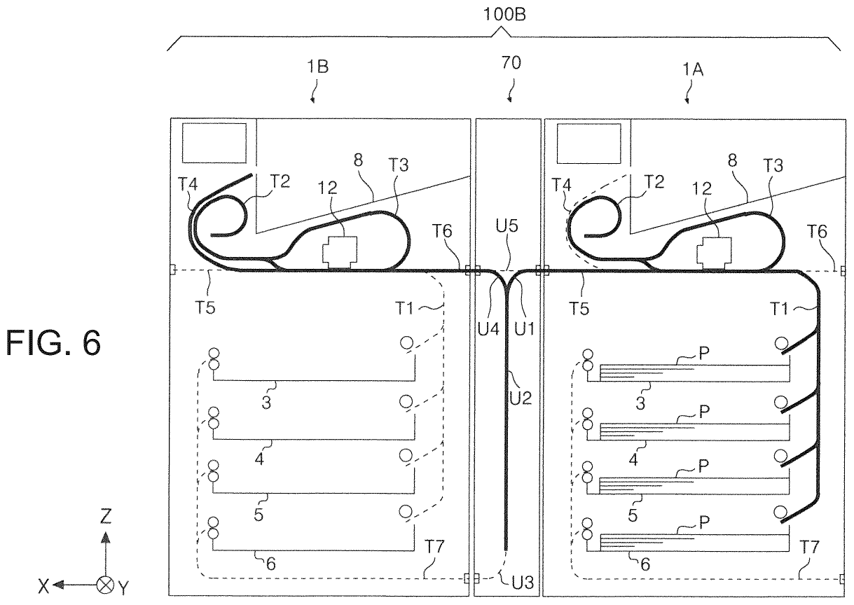

Next, a liquid ejection system 100B shown in FIG. 6 is provided with the inversion section 70 between the first liquid ejection device 1A and the second liquid ejection device 1B.

In the liquid ejection system 100B, the medium is sent to the inversion section 70 after the liquid is ejected by the first liquid ejection device 1A. Then, the front and back sides are inversed using the switchback path U2, it is sent to the second liquid ejection device 1B, and the liquid is ejected by the second liquid ejection device 1B.

In the first liquid ejection device 1A, as an example, the pre-processing liquid is ejected onto the medium, and in the second liquid ejection device 1B, as an example, the ink is ejected onto the medium.

In FIG. 6, thick solid line indicates the medium transport path when such liquid eject is performed. A medium indicated by a reference symbol P is sent out from any of the medium cassettes of the first liquid ejection device 1A, inversed after the pre-processing liquid is ejected onto a first surface, and then the pre-processing liquid is ejected onto a second surface. Then, it is inversed by the inversion section 70, sent to the second liquid ejection device 1B, it is inversed after recording is performed on the first surface, recording is performed on the second surface, and is discharged to the discharge tray 8.

According to such a usage aspect of the liquid ejection system 100B, unlike the liquid ejection system 100A described above, since the order of the pre-processing to the first surface of the medium, the pre-processing to the second surface, the recording to the first surface, and the recording to the second surface is performed, it is possible to suppress the occurrence of a large difference in the time from the pre-processing to the recording between the first surface and the second surface.

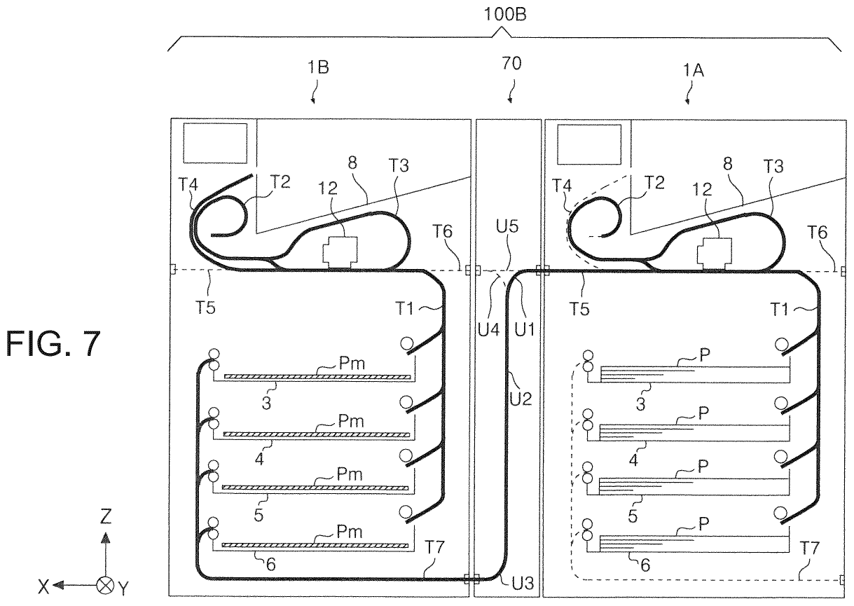

Next, FIG. 7 shows another utilization form of the liquid ejection system 100B.

In the present embodiment, the medium on which the liquid is ejected by the first liquid ejection device 1A is received by the second liquid ejection device 1B and the received medium is carried into each of the medium cassettes using the carry-in path T7. Then, the medium carried into each medium cassette is fed and the liquid is ejected. In FIG. 7, reference symbol Pm indicates the medium carried into each medium cassette.

According to such a usage aspect, it is possible to secure the drying time by accommodating the medium on which the liquid is ejected by the first liquid ejection device 1A in each of the medium cassettes of the second liquid ejection device 1B. By using the medium cassettes, which are constituent elements for feeding the medium, it is not necessary to provide a dedicated medium storage location and it is possible to achieve miniaturization of the device.

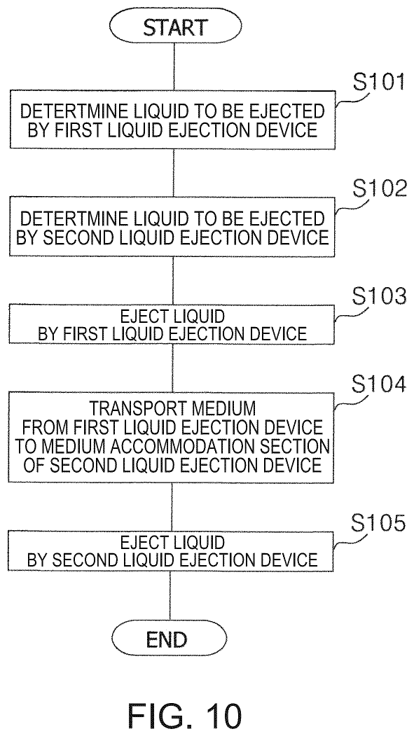

A control method for realizing such a utilization form, that is, a control method of the liquid ejection system 100B realized by the control section 80 can be represented by a flowchart shown in FIG. 10.

First, it is determined whether or not the liquid ejected from the liquid ejection section 12 included in the first liquid ejection device 1A is the ink or the processing liquid (step S101). Note that the determination of the processing liquid includes determining whether or not the processing liquid is the pre-processing liquid or the post-processing liquid. This determination can be performed based on the information of the cartridge IC described above as an example. Next, it is determined whether or not the liquid ejected from the liquid ejection section 12 included in the second liquid ejection device 1B is the ink or the processing liquid (step S102). Note that the determination of the processing liquid includes determining whether or not the processing liquid is the pre-processing liquid or the post-processing liquid. This determination can be performed based on the information of the cartridge IC described above as an example.

Next, when one of the liquids ejected from the liquid ejection section 12 of the first liquid ejection device 1A and the second liquid ejection device 1B is the ink and the other is the processing liquid, the liquid is ejected by the first liquid ejection device 1A (step S103) and the medium from which the liquid has been ejected is carried into the medium cassette of the second liquid ejection device 1B (step S104). Then, the liquid is ejected by the second liquid ejection device 1B (step S105). Note that the combination of the liquids ejected by the first liquid ejection device 1A and the second liquid ejection device 1B may be a combination of the pre-processing liquid and the ink or a combination of the ink and the post-processing liquid.

According to such a control method, when one of the liquids ejected from the liquid ejection sections 12 of the first liquid ejection device 1A and the second liquid ejection device 1B is the ink and the other is the processing liquid, the medium on which the liquid was ejected by the first liquid ejection device 1A is accommodated in the medium cassette of the second liquid ejection device 1B so that the drying time can be secured. By using the medium cassettes, which is a constituent element for feeding the medium, it is not necessary to provide a dedicated medium storage location and it is possible to achieve a reduction in the size of the device.

Here, the order of carrying into each medium cassette and the order of carrying out at the time of sheet feeding can be set as appropriate, but it is a desirable aspect that the drying time of the medium can be secured. For example, when the plurality of medium cassettes is used, it is desirable not to immediately feed the medium that was just carried into a predetermined medium cassette, but rather to feed the medium that was previously carried into another medium cassette first.

It is not necessary to use all of the plurality of medium cassettes, and one or a plurality of arbitrary medium cassettes may be used.

As an example, when the medium is carried in, the medium is carried in the order of the first medium cassette 3, the second medium cassette 4, the third medium cassette 5, and the fourth medium cassette 6. Thereafter, by feeding the medium in the same order, the drying time of the medium can be secured and the drying time can be made uniform in each medium cassette. Note that instead of carrying in and feeding the medium from the upper medium cassette to the lower medium cassette in this order, the medium may be carried in and fed from the lower medium cassette to the upper medium cassette in order.

The medium may be carried into one medium cassette in advance up to the accommodation limit, and while the medium is fed from the medium cassette until the medium runs out, the medium may be accommodated in another medium cassette up to the accommodation limit.

It is also possible to adopt a configuration in which the medium is taken out from the bottom of the carried-in medium while the medium is carried in from above the medium cassette.

The carrying in of the medium into each medium cassette and the ejecting of the liquid by the second liquid ejection device 1B without carrying in of the medium into each medium cassette using the skip path U5 of the inversion section 70 may be used together.

When the throughput in the first liquid ejection device 1A is higher than the throughput in the second liquid ejection device 1B, one medium cassette may be used as a buffer, and sequential carrying in and feeding may be performed using another medium cassette. When the processing overflows, the received medium may be evacuated to the medium cassette used as the buffer.

In this manner, the second liquid ejection device 1B includes the plurality of medium cassettes. When one of the plurality of medium cassettes is set as the first medium accommodation section and the other is set as the second medium accommodation section, the second liquid ejection device 1B can execute a step of carrying the received first medium into the first medium accommodation section, a step of carrying the second medium received next to the first medium into the second medium accommodation section, and a step of feeding the second medium to the liquid ejection section 12 after feeding the first medium to the liquid ejection section 12.

Accordingly, the drying time can be secured because the medium is fed from the medium fed first by using the two medium cassettes.

In the present embodiment, the second liquid ejection device 1B feeds the first medium carried into the first medium accommodation section to the liquid ejection section 12, and then carries the received medium into the first medium accommodation section. Accordingly, it is possible to prevent the use order of the medium previously carried into the first medium accommodation section and the medium subsequently carried into the first medium accommodation section from being reversed.

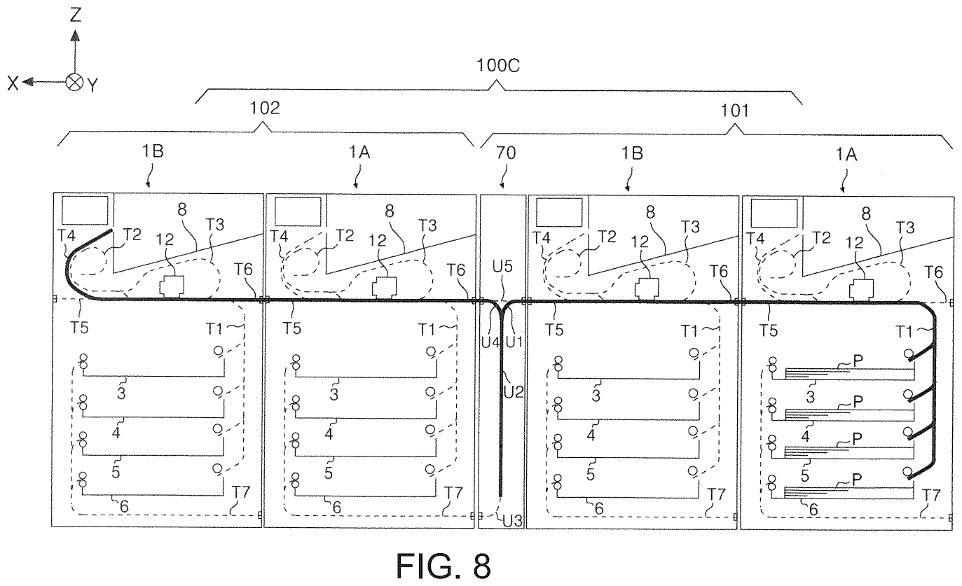

Next, a liquid ejection system 100C shown in FIG. 8 includes a first unit 101 that is a pair of the first liquid ejection device 1A and the second liquid ejection device 1B, and a second unit 102 that is a pair of the first liquid ejection device 1A and the second liquid ejection device 1B.

The first unit 101 includes the inversion section 70 that inverses the front and back of the medium and transports the medium to the second unit 102.

In a case where the first unit 101 and the second unit 102 are provided, after the liquid is ejected onto the first surface of the medium by the first liquid ejection device 1A of the first unit 101, the liquid can be ejected onto the first surface of the medium by the second liquid ejection device 1B of the first unit 101. Thereafter, after the liquid is ejected onto the second surface of the medium by the first liquid ejection device 1A of the second unit 102, the liquid can be ejected onto the second surface of the medium by the second liquid ejection device 1B of the second unit 102. The combination of the liquid to be ejected by each unit may be a combination of the pre-processing and the ink, a combination of the ink and the post-processing, or another combination.

That is, when printing is performed on both sides of the medium, the control method of the liquid ejection system 100C includes causing the first unit 101 to eject the liquid onto the first surface of the medium and causing the second unit 102 to eject the liquid onto the second surface opposite to the first surface of the medium.

Here, the time that is referred to as time Tm1 is from when the liquid is ejected onto the first surface of the medium by the first liquid ejection device 1A of the first unit 101 to when the liquid is ejected onto the first surface of the medium by the second liquid ejection device 1B of the first unit 101.

The time that is referred to as time Tm2 is from when the liquid is ejected onto the second surface of the medium by the first liquid ejection device 1A of the second unit 102 to when the liquid is ejected onto the second surface of the medium by the second liquid ejection device 1B of the second unit 102.

According to the present aspect, since the first unit 101 includes the inversion section 70 that inverses the front and back of the medium and transports the medium to the second unit 102, it is possible to suppress the difference between the time Tm1 and the time Tm2. Accordingly, it is possible to suppress a difference in recording quality between the first surface and the second surface of the medium.

Note that even with the configuration of the liquid ejection system 100B described above, it is possible to suppress the difference between the time Tm1, that is, the time from the first ejection of the liquid onto the first surface of the medium to the next ejection of the liquid, and the time Tm2, that is, the time from the first ejection of the liquid onto the second surface of the medium to the next ejection of the liquid.

At this time, it is desirable that the first liquid ejection device 1A and the second liquid ejection device 1B take the same time to inverse the medium in the switchback path T2 and the inversion path T3. That is, the liquid ejection system 100B as described above can suppress the difference between the time Tm1 and the time Tm2 while suppressing an increase in the size of the system in the X-axis direction and thus can suppress the difference between the recording qualities of the first surface and the second surface of the medium.

On the other hand, while the liquid is ejected onto the second surface of the medium in the liquid ejection system 100B, the liquid cannot be ejected onto the first surface of the subsequent medium, but by consecutively transporting the medium in the liquid ejection system 100C, the eject of the liquid onto the second surface of the medium and the eject of the liquid onto the first surface of the other medium can be performed in parallel. The number of times of inversion of the medium in the liquid ejection system 100C is smaller than that in the liquid ejection system 100B. Therefore, the liquid ejection system 100C can suppress the difference between the time Tm1 and the time Tm2 while improving the throughput and thus can suppress the difference in recording quality between the first surface and the second surface of the medium.

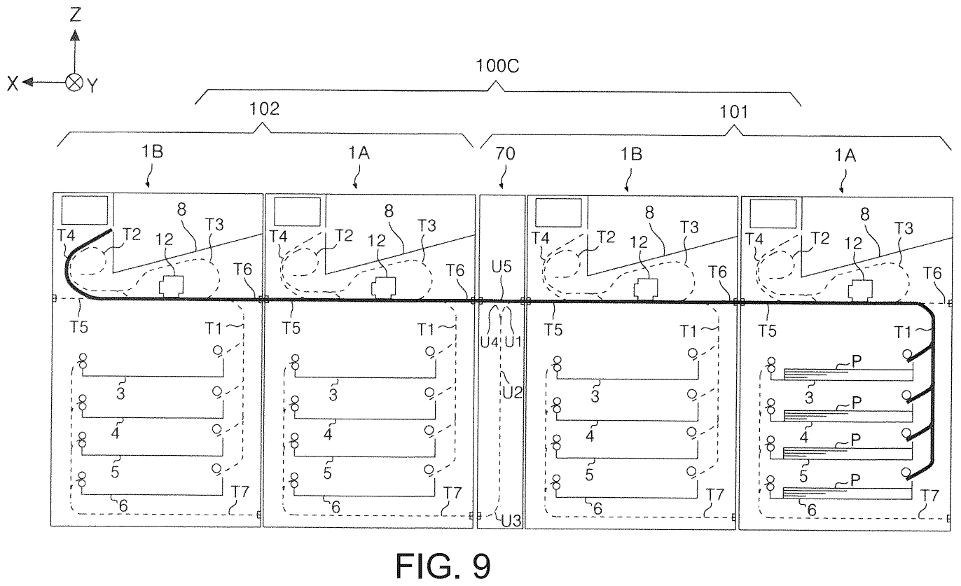

Next, FIG. 9 shows another utilization form of the liquid ejection system 100C.

In a case where the liquid is ejected onto only one side of the medium using the skip path U5 of the inversion section 70, the liquid may be ejected onto the medium by the first liquid ejection device 1A of the first unit 101, and then the liquid may be ejected onto the medium by the second liquid ejection device 1B of the second unit 102. The combination of the liquid to be ejected first and the liquid to be ejected later may be a combination of the pre-processing and the ink, a combination of the ink and the post-processing, or another combination.

That is, when ejecting the liquid onto only one side of the medium using the skip path U5, the control method of the liquid ejection system 100C includes ejecting the liquid onto the medium by the first liquid ejection device 1A of the first unit 101, and then ejecting the liquid onto the medium by the second liquid ejection device 1B of the second unit 102.

According to such an aspect, it is possible to gain a transport time from when the liquid is first ejected onto the medium to when the liquid is next ejected onto the medium. Accordingly, the drying time can be increased and good recording quality can be obtained.

### Control Related to Mounting of Liquid Container

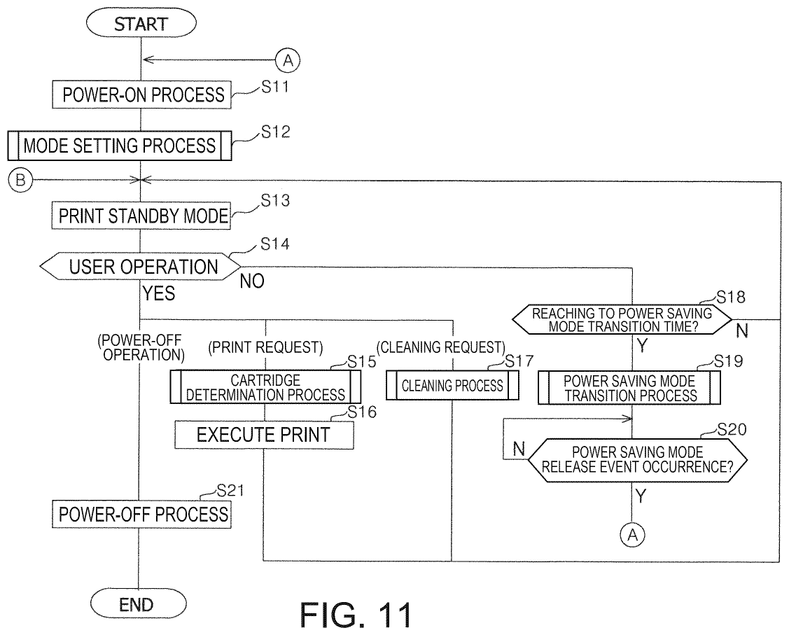

Next, among the controls performed by the control section 80 of the liquid ejection device 1, a control relating to the mounting of the liquid container, that is, the cartridge, on the mount section 200 will be described with reference to FIG. 11 to FIG. 15.

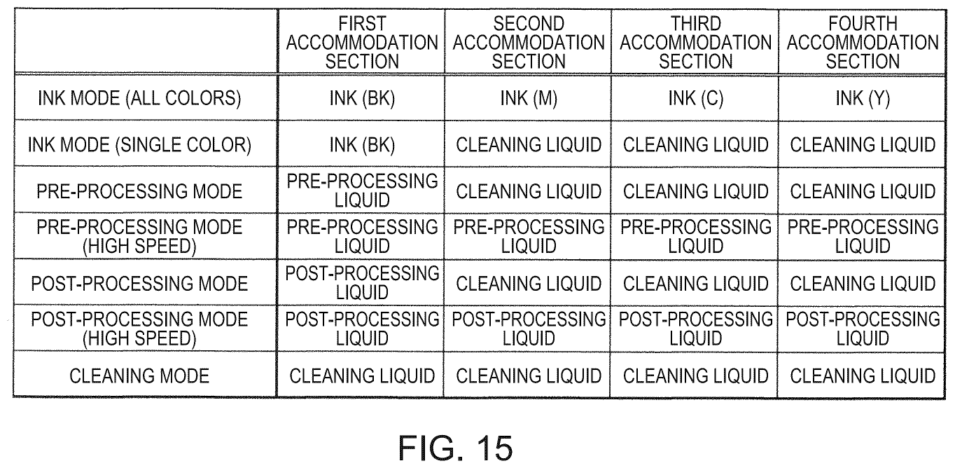

First, the liquid ejection modes of the liquid ejection device 1 will be described with reference to FIG. 15. The liquid ejection device 1 according to the present embodiment can execute any one of the liquid ejection modes shown in FIG. 15 in accordance with the type of the cartridge mounted on the mount section 200. In FIG. 15, the label “ink” means the ink cartridge, the label “pre-processing liquid” means the pre-processing liquid cartridge, the label “post-processing liquid” means the post-processing liquid cartridge, and the label “cleaning liquid” means the cleaning liquid cartridge.

Note that in the present specification, the term “liquid ejection mode” refers to the state of the liquid ejection device I according to the type of cartridge mounted on the mount section 200. The execution of the liquid ejection mode means that processing corresponding to the liquid ejection mode is actually performed. For example, the execution of an ink mode means that the ink is ejected onto the medium, the execution of the processing mode means that the processing liquid is ejected onto the medium, and the execution of the cleaning mode means that the cleaning of the flow path Fr is executed.

In the present embodiment, any one of the ink cartridge (BK), the pre-processing liquid cartridge, the post-processing liquid cartridge, and the cleaning liquid cartridge can be mounted on the first accommodation section 211.

Any one of the ink cartridge (M), the pre-processing liquid cartridge, the post-processing liquid cartridge, and the cleaning liquid cartridge can be mounted on the second accommodation section 212.

Any one of the ink cartridge (C), the pre-processing liquid cartridge, the post-processing liquid cartridge, and the cleaning liquid cartridge can be mounted on the third accommodation section 213.

Any one of the ink cartridge (Y), the pre-processing liquid cartridge, the post-processing liquid cartridge, and the cleaning liquid cartridge can be mounted on the fourth accommodation section 214.

The relationship between the type of the cartridge mounted on each accommodation section and the liquid ejection mode is as shown in FIG. 15. In the present embodiment, the liquid ejection device 1 can execute any one of the ink mode (all colors), the ink mode (single color), the pre-processing mode, the pre-processing mode (high speed), the post-processing mode, the post-processing mode (high speed), and the cleaning mode. Note that it is not necessarily necessary to execute all of these modes. Modes other than the above may be provided.

The ink mode (all colors) and the ink mode (single color) are examples of a recording mode when recording is performed on the medium using the ink, which is an example of the recording liquid. The pre-processing mode, the pre-processing mode (high speed), the post-processing mode, and the post-processing mode (high speed) are examples of the processing modes in the case of processing the medium with the processing liquid. The cleaning mode is a mode in which the flow path Fr is cleaned by the cleaning liquid.

The control method of the liquid ejection device I realized by the control section 80 includes executing the above modes.

Each of the above modes allows for appropriate recording, processing, and cleaning.

Note that it is necessary to mount some type of cartridge in each of the accommodation sections. This is because if cartridges are not mounted on all of the accommodation sections, for example, when the liquid is sucked from the nozzles 13 by generating the negative pressure in the cap 9a, the negative pressure is not appropriately formed, and there is a concern that suction cannot be achieved. Therefore, for example, in the ink mode (single color), the pre-processing mode, and the post-processing mode, a necessary cartridge is mounted on the first accommodation section 211, and a cleaning liquid cartridge is mounted on the other accommodation sections. In addition to the ink mode (single color), a mode may be provided in which an ink cartridge is mounted on the accommodation section of an arbitrary color, and the cleaning liquid cartridge is mounted on other accommodation sections. According to such a mounting aspect, the liquid consumption cost can be suppressed as compared with a case where only the cartridge of the first accommodation section 211 is used while the ink cartridges or the processing liquid cartridges are mounted on the accommodation sections other than the first accommodation section 211. This is because the cleaning liquid is inexpensive in most cases as compared with the ink or the processing liquid, and even when the liquid is ejected using only the cartridge of the first accommodation section 211, the liquid of the cartridges of the other accommodation sections is also consumed at the time of maintenance of the liquid ejection section 12. Therefore, by these modes, it is possible to customize the liquid ejection device 1 in accordance with the printing result desired by the user while suppressing the cost.

Next, processing performed by the control section 80 will be described with reference to FIG. 11 to FIG. 14.

FIG. 11 is a main flow of the control relating to the mounting of the liquid container, that is, the cartridge on the mount section 200.

When the power of the device is turned on, the control section 80 performs a power-on process (step S11). Here, the power-on of the device is not limited to a case where the power button (not shown) included in the operation panel 86 is pressed and includes a case where the device returns from the power saving mode. The power-on process here is a general initialization process of the printer, and includes, for example, home detection of a movable portion, a reset operation, and the like.

Next, the control section 80 performs a mode setting process (step S12). The mode here is the liquid ejection mode described with reference to FIG. 15. In this mode setting process, it is confirmed whether or not the cartridge mounted on the mount section 200 matches the liquid ejection mode grasped by the control section 80, and if not, necessary predetermined processing is performed. That is, in the power-off state, there is a possibility that the cartridge mounted on the mount section 200 has been replaced by the user, and therefore, this is confirmed in the mode setting process.

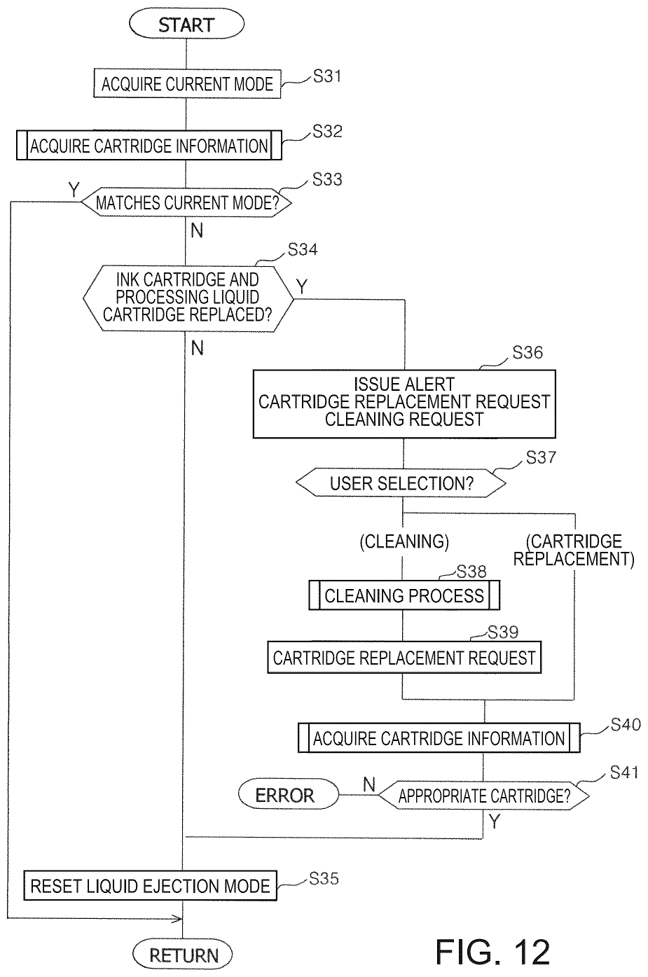

Hereinafter, the mode setting process will be described with reference to FIG. 12.

The control section 80 acquires the current mode (step S31). The current mode is stored in the nonvolatile memory 83 (see FIG. 2). Next, the control section 80 acquires the information of the cartridge mounted on the mount section 200 from the cartridge IC (step S32) and determines whether or not the current mode matches with the current mode (step S33).

As a result, if it matches the current mode (Yes in step S33), the process returns to the main flow of FIG. 11. On the other hand, if it does not match the current mode (No in step S33), it is determined whether or not the ink cartridge and the processing liquid cartridge have been replaced (step S34).

When the ink cartridge and the processing liquid cartridge have not been replaced with each other (No in step S34), the liquid ejection mode is reset according to the type of the mounted cartridge (step S35). The resetting of the liquid ejection mode includes a process of storing information related to the liquid ejection mode after the change in the nonvolatile memory 83 (see FIG. 2).

When the ink cartridge and the processing liquid cartridge have been replaced with each other (Yes in step S34), an alert is issued to the operation panel 86, and a user interface prompts the user to select either the cartridge replacement or the cleaning processing is displayed (step S36). Note that the term “user interface” will be abbreviated as “UI” hereinafter.

As an example, the above UI may include a message such as, “A cartridge replacement that requires cleaning has been detected. Please select whether to replace the cartridge after cleaning or the replacement of the cartridge that does not require cleaning”.

That is, in the case where the processing liquid cartridge is mounted on the accommodation section in which the ink cartridge was mounted or in the case where the ink cartridge is mounted on the accommodation section in which the processing liquid cartridge was mounted, there is a possibility that the ink and the processing liquid will be mixed and the viscosity of the liquid will increase to cause clogging of the flow path Fr or the like. Therefore, in this case, the process of filling the flow path Fr with the new liquid is not performed and the UI including the alert as described above is presented to the user.

In this case, as a measure taken by the user, either the cartridge is replaced as originally planned after the cleaning or the cartridge is replaced with one that does not require cleaning. Examples of the replacement of the cartridge that does not require cleaning include replacement between the ink cartridge and the cleaning liquid cartridge and replacement between the processing liquid cartridge and the cleaning liquid cartridge. Of course, the replacement of the cartridge that does not require cleaning includes the replacement of the cartridge back to the original type.

If the user selection (step S37) is cartridge replacement after cleaning, the control section 80 performs cleaning process (step S38) and then displays a replacement request to change to the cartridge originally scheduled for replacement on the operation panel 86 (step S39).

If the user selection (step S37) is the replacement to a cartridge that does not require cleaning, the process proceeds to step S40.

In any case of the user selection, the user presses, for example, a “replacement completion button” displayed on the UI of the operation panel 86 after replacing the cartridge. In response to this, the control section 80 acquires the information of the cartridge IC of the cartridge mounted on the mount section 200 (step S40) and if the mounted cartridge is appropriate (Yes in step S41), the process proceeds to step S35.

If the mounted cartridge is not appropriate (No in step S41), an error process is performed. That the mounted cartridge is appropriate means any of the combinations of cartridges shown in FIG. 15. Particularly, as an example in which the mounted cartridge is inappropriate, there is a state in which the ink cartridge and the processing liquid cartridge are mounted at the same time.

In step S35, the liquid ejection mode is reset in accordance with the type of the mounted cartridge, as described above.

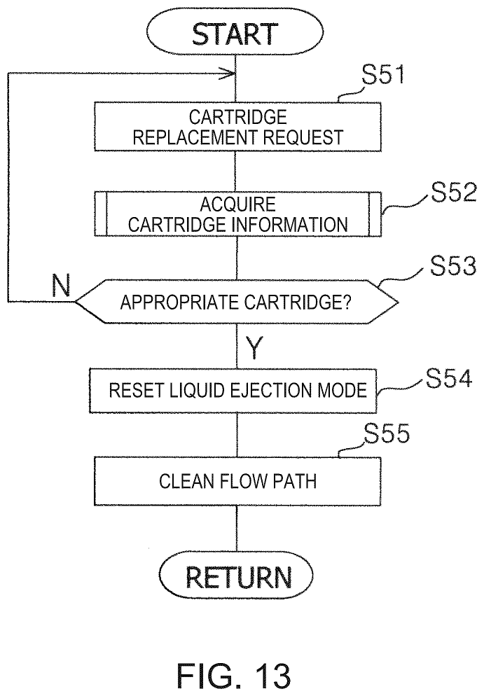

Note that the cleaning process in step S38 will be described with reference to FIG. 13. In the cleaning process, the control section 80 causes the operation panel 86 to display a UI for prompting mounting of the cleaning liquid cartridge (step S51). After the user mounts the cleaning liquid cartridge, when the “replacement completion button” displayed on the UI of the operation panel 86 is pressed, the control section 80 acquires information of the cartridge IC of the cartridge mounted on the mount section 200 (step S52). As a result, if the mounted cartridge is appropriate (Yes in step S53), the liquid ejection mode is reset, that is, the liquid ejection mode is set to the cleaning mode (step S54) and the flow path Fr is cleaned (step S55). Here, the mounted cartridge is appropriate means that the cleaning liquid cartridge is mounted on the accommodation section of the flow path Fr that needs to be cleaned.

The cleaning of the flow path Fr is a process of ejecting the cleaning liquid from the nozzles 13 to the cap 9a or a process of generating a negative pressure in the cap 9a and sucking the cleaning liquid from the nozzles 13. As this process, the same process as the maintenance for the purpose of preventing clogging of the liquid ejection section 12 in a state where the ink cartridge is mounted, specifically, the sequence of the flushing process or the nozzle suction process may be used as is. Alternatively, the sequence for performing the initial filling of ink may be used as is. Alternatively, it may be a sequence dedicated to the cleaning liquid. Further, these sequences may be repeated, whereby a more reliable cleaning can be performed.

Note that if the mounted cartridge is not appropriate (No in step S53), the process returns to step S51.

The above is the mode setting process, and hereinafter, returning to FIG. 11, step S13 and the subsequent steps of the main flow will be described.

After the mode setting process in step S12 is completed, the control section 80 enters a print standby mode (step S13). The print standby mode is a mode for waiting for a user operation.

In contrast, there is no user operation (No in step S14), when reaching the power saving mode transition time (Yes in step S18), the control section 80 performs the power saving mode transition process (step S19). As a result, the liquid ejection device 1 enters a power saving state in which power is supplied only to necessary parts.

In the power saving mode state, when the power saving mode release event such as a user touching the operation panel 86 or pressing the power button (not shown) occurs (Yes in step S20), the process returns to step S11. Note that when the user issues a print request in the power saving mode state, the control section 80 performs the power-on process (step S11), and then executes step S15 and subsequent steps (to be described later).

Next, when there is a user operation in the print standby mode state (“Yes” in step S14), if the content is a power-off operation, the control section 80 performs a power-off process (step S21), and the process ends.

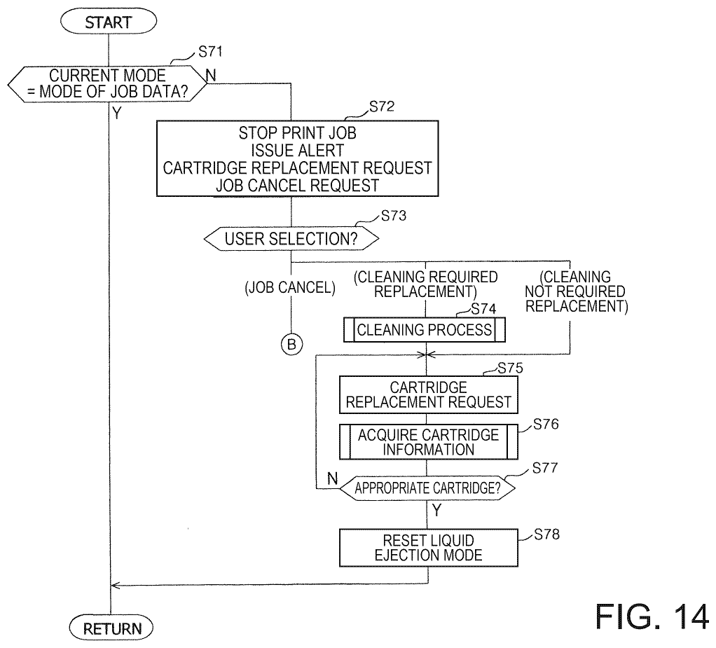

If the content of the user operation is the print request, that is, if the control section 80 receives print job data, the process proceeds to step S15 and performs the cartridge determination process. Hereinafter, this cartridge determination process will be described with reference to FIG. 14.

First, the control section 80 determines whether or not the current liquid ejection mode matches the liquid ejection mode of the print job data (step S71). As a result, if they match with each other (Yes in step S71), the process returns to the main flow.

If the current liquid ejection mode and the liquid ejection mode of the print job data do not match with each other (No in step S71), the print job is stopped, an alert is issued to the operation panel 86, and the UI prompting the user to select either cartridge replacement or job cancellation is displayed (step S72). An example of the above UI may include a message such as, “The mounted cartridge is not suitable. Please select whether or not to replace the cartridge or to stop printing.”

If the user selection (step S73) is the job cancellation, the process returns to step S13 of the main flow.

If the user selection (step S73) is the cartridge replacement and the replacement requires cleaning of the flow path Fr, the process proceeds to step S74 and the cleaning process of the flow path Fr is performed. This cleaning process is the same as the process described with reference to FIG. 13. When the cleaning process is completed, the control section 80 displays on the operation panel 86 a replacement request to a cartridge suitable for the liquid ejection mode of the print job data (step S75).

After the user has replaced the cartridge, for example, the user presses the “replacement completion button” displayed on the UI of the operation panel 86. In response to this, the control section 80 acquires the information of the cartridge IC of the cartridge mounted on the mount section 200 (step S76) and if the mounted cartridge is suitable for the liquid ejection mode of the print job data (Yes in step S77), the control section 80 resets the liquid ejection mode (step S78) and returns to the main flow.

If the mounted cartridge is not appropriate (No in step S77), the process returns to step S75.

Note that if the user selection (step S73) is the cartridge replacement and the replacement does not require cleaning of the flow path Fr, the process proceeds to step S75 without performing the cleaning process.

Returning to the main flow of FIG. 11, the control section 80 executes printing (step S16) and returns to the print standby mode.

Next, in the main flow of FIG. 11, when the content of the user operation in step S14 is the cleaning process, the flow proceeds to step S17 and the cleaning process of the flow path Fr is performed. This cleaning process is the same as the process described with reference to FIG. 13.

As described above, in switching from either the recording mode or the processing mode to the other, the control section 80 interposes the cleaning of the flow path Fr in the cleaning mode (step S38 in FIG. 12 and step S74 in FIG. 14).

That is, the control method of the liquid ejection device 1 realized by the control section 80 executes the cleaning mode before switching from either the recording mode or the processing mode to the other mode (step S38 in FIG. 12, step S74 in FIG. 14).

Accordingly, mixing of the ink and the processing liquid can be suppressed and good results can be obtained.

Based on the received job data, the control section 80 detects switching from either the recording mode or the processing mode to the other (step S71 in FIG. 14) and interposes cleaning of the flow path Fr by the cleaning mode (step S74 in FIG. 14).

That is, the control method of the liquid ejection device 1 realized by the control section 80 includes receiving job data (print request of user operation “Yes” in FIG. 11), collating the liquid ejection mode included in the job data with the current liquid ejection mode (step S71 in FIG. 14) and executing the cleaning mode when the liquid ejection mode included in the job data does not match with the current liquid ejection mode (step S74 in FIG. 14).

Accordingly, it is possible to handle cases where the user transmits the job data without being aware of the current mode.

Note that the control section 80 may detect the mounting of the cartridge on the mount section 200, detect the switching from either the recording mode or the processing mode to the other based on the detection, and cause interposition of the cleaning of the flow path Fr in the cleaning mode.

For example, in the print standby mode (step S13 in FIG. 11), the control section 80 acquires the cartridge information at predetermined time intervals and when the cartridge corresponding to switching from either the recording mode or the processing mode to the other is replaced, the cleaning process (see FIG. 13) may be performed.

That is, the control method of the liquid ejection device I realized by the control section 80 includes determining the liquid contained in the liquid container mounted on the mount section 200 and collating the liquid ejection mode corresponding to the determined liquid with the liquid ejection mode grasped by the control section 80, and the cleaning mode is executed if the liquid ejection mode suitable for the determined liquid does not match the current liquid ejection mode.

Accordingly, usability is improved as compared with a case where the user executes the cleaning mode by the user self.

Note that when it is detected that the cleaning liquid cartridge is mounted, the flow path cleaning (step S55 of FIG. 13) may be executed without performing the user confirmation.

The control section 80 detects switching from either the recording mode or the processing mode to the other based on an input from the operation panel 86 that receives the operation setting of the user, the cleaning of the flow path Fr by the cleaning mode may be interposed. The input from the operation panel 86 includes, as an example, printing associated with the execution of a copy function, an instruction for execution of the pre-processing and the post-processing, and the like. Accordingly, usability is improved as compared with a case where the user executes the cleaning mode by the user himself.

Note that the site for accepting the user's operation setting is not limited to the operation panel 86 provided in the liquid ejection device 1 and may be an external device connected to the liquid ejection device 1, for example, a computer or the like.

The ink cartridge, the processing liquid cartridge, and the cleaning liquid cartridge have the cartridge IC which is an information holding section that holds liquid information and is an information holding section that can be accessed by the control section 80. When the power of the device is turned on, the control section 80 accesses the cartridge IC (step S32 in FIG. 12), and when the replacement from either the ink cartridge or the processing liquid cartridge to the other is performed (Yes in step S34 in FIG. 12) in comparison with the liquid information in the previous access to the cartridge IC (step S33 in FIG. 12), the alert is issued (step S36 in FIG. 12).

Accordingly, mixing of the ink and the processing liquid can be suppressed and good results can be obtained.

In the present embodiment, the cleaning mode is a mode in which the flow path Fr is cleaned by performing maintenance using the cleaning liquid and the cap 9a. As a result, the flow path Fr can be cleaned with easy workability. At the same time, the cap 9a can also be cleaned.

The liquid ejection device 1 further includes the waste liquid storage section 17 (refer to FIG. 3), which stores waste liquid generated in the cap 9a, and the cleaning liquid used in the cleaning mode is discharged to the waste liquid storage section 17. That is, in addition to the ink, the cleaning liquid that has finished cleaning the flow path Fr is also discharged to the waste liquid storage section 17. Accordingly, it is not necessary to prepare a dedicated waste liquid storage section 17 when the flow path Fr is cleaned, and usability is improved.

Note that when the processing liquid cartridge is mounted, the processing liquid is also discharged to the waste liquid storage section 17. Accordingly, the ink, the processing liquid, and the cleaning liquid may be discharged to the waste liquid storage section 17.

When the cleaning in the cleaning mode is not completed in either the recording mode or the processing mode, the control section 80 restricts the cartridge used in the other mode from being mounted on the mount section 200. This is realized by, as an example, step S36 in FIG. 12 or the flow from step S72 to step S74 in FIG. 14. Accordingly, mixing of the ink and the processing liquid can be suppressed.

Note that strictly speaking, restriction here is not a restriction on the mounting itself of the cartridge, but means that an inappropriate mounting state where the cartridge is prevented from continuing. However, mounting of the cartridge itself may be restricted. Such an embodiment will be described later.

The mount section 200 can mount a first ink cartridge containing ink of a first color and a second ink cartridge containing ink of a second color different from the first color. The first color here is any one of black, magenta, cyan, and yellow in the present embodiment, and the second color means any one of the others.

However, it is not limited to this, and the mount section 200 may be capable of mounting only an ink cartridge of one color, for example, a black ink cartridge.

Only one cartridge may be mountable on the mount section 200.

The mount section 200 has a first mount region on which the first ink cartridge is mounted and a second mount region on which the second ink cartridge is mounted. Here, the first mount region is at least one of the first accommodation section 211, the second accommodation section 212, the third accommodation section 213, and the fourth accommodation section 214, and the second mount region is at least one of the other accommodation sections. The same applies to the first mount region and the second mount region described below.

Here, the control section 80 may perform an error process in a case where the processing liquid cartridge is mounted on either the first mount region or the second mount region and the ink cartridge is mounted on the other. This error process is, as an example, an error process branched by No in step S41 of FIG. 12.

As a specific process of this error process, the following may be performed. For example, it is assumed that the user selection in step S37 of FIG. 12 is a case where the replacement of a cartridge that does not require cleaning, and the current mode is the processing mode. Then, in a case where the processing liquid cartridge is mounted on the first mount region and the ink cartridge is mounted on the second mount region, that is, in a case of No in step S41, the mounting of the cleaning liquid cartridge or the processing liquid cartridge in the second mount region may be prompted by the UI of the operation panel 86.

That is, the control method realized by the control section 80 may include determining the type of the liquid container mounted on the first mount region and in the second mount region and, when the current mode is the processing mode, the processing liquid cartridge is mounted on the first mount region, and the ink cartridge is mounted on the second mount region, prompting that the cleaning liquid cartridge or the processing cartridge be mounted on the second mount region. However, it is desirable that the mounting of the processing liquid cartridge on the second mount region is prompted only when the cleaning of the flow path Fr is completed.

By doing so, mixing of the ink and the processing liquid can be suppressed.

Note that when the processing mode is executed in a state where the processing liquid cartridge is mounted on the first mount region and the cleaning liquid cartridge is mounted on the second mount region, it is also desirable that the control section 80 converts the image data included in the job data into data of the first color.

A specific example will be described below. In the case of the pre-processing mode of FIG. 15, the pre-processing liquid cartridge is mounted on the first accommodation section 211, and cleaning liquid cartridges are mounted on the second accommodation section 212, the third accommodation section 213, and the fourth accommodation section 214. The first color shall be black.

When the print data is a color image, the liquid is supplied from the first accommodation section 211 and ejected to pixels that use the black ink, the liquid is supplied from the second accommodation section 212 and ejected to pixels that use the magenta ink, the liquid is supplied from the third accommodation section 213 and ejected to pixels that use the cyan ink, and the liquid is supplied from the fourth accommodation section 214 and ejected to pixels that use the yellow ink.

Under such a premise, in a case where the pre-processing is performed on the medium in the pre-processing mode and the print data is used as is, if no processing is performed, the pre-processing liquid is appropriately supplied and ejected from the first accommodation section 211 to the pixels that use the black ink. However, for pixels that use ink of other colors, the cleaning liquid is supplied and ejected from the second accommodation section 212, the third accommodation section 213, and the fourth accommodation section 214, and thus the pre-processing liquid cannot be appropriately ejected.

If the cleaning liquid is not ejected from the second accommodation section 212, the third accommodation section 213, and the fourth accommodation section 214, the liquid is not ejected to the pixels that use color inks other than the black ink, and thus it is not possible to appropriately ejected the pre-processing liquid. Therefore, the control section 80 converts colors other than black in the image data included in the job data into black. In this way, regardless of the color, the pre-processing liquid is supplied from the pre-processing liquid cartridge accommodated in the first accommodation section 211, and the pre-processing liquid is ejected to all the pixels. In this way, there is no need for the user to send the image data whose color has been adjusted in advance as the job data and usability is improved. Note that at the time of conversion, the image data may be converted with a uniform density or with a density based on the image data.

As described above, the control method of the liquid ejection device 1 realized by the control section 80 includes receiving the image data of the print job, determining the liquid contained in the liquid container mounted on the mount section 200, and converting the image data into the data of the first color when the current liquid ejection mode is the processing mode and the liquid container containing the processing liquid is mounted on the first mount region.

The processing liquid cartridge and the cleaning liquid cartridge can be mounted on the first mount region and the second mount region. In FIG. 15, for example, when the first mount region is the first accommodation section 211 and the second mount region is the second accommodation section 212, the processing liquid cartridge and the cleaning liquid cartridge can be mounted on the first accommodation section 211 and the second accommodation section 212.

Accordingly, the plurality of processing liquid cartridges can be used. For example, different types of processing liquids can be mounted on the first accommodation section 211 and the second accommodation section 212 and used. By ejecting the same type of processing liquid from the first accommodation section 211 and the second accommodation section 212 at the same time, it is possible to improve throughput when ejecting the processing liquid onto the medium. The pre-processing mode (high speed) and the post-processing mode (high speed) in FIG. 15 are examples of modes capable of obtaining such an effect. Specifically, the nozzles from which the processing liquid supplied from the processing liquid cartridge mounted on the first accommodation section 211 is ejected and the nozzles from which the processing liquid supplied from the processing liquid cartridge mounted on the second accommodation section 212 is ejected may be disposed so that the ejection regions overlap each other. In such a case, by ejecting the processing liquid from both nozzles, it is possible to speed up the process even at the same ejection interval. This tendency is more remarkable in the case of the serial printing method.

Note that as long as the liquids do not cause an adverse effect even if they are mixed with each other, not limited to the example of FIG. 15, a different cartridge may be mounted on the mount section 200.

When the cartridges of the same type of liquid are mounted on a plurality of places, it is possible to suppress the replacement frequency of cartridges by preferentially using cartridges in which the liquid remaining amount is large.

Regarding the control related to the mounting of the liquid container described above, the following modified examples can be employed.
In the present embodiment, the liquid ejection section 12 is the line head and the mount section 200 is fixedly provided. However, as described above, the liquid ejection section 12 may be the ink ejection head that is mounted on the carriage and ejects liquid while moving in the medium width direction. In this case, the mount section 200 may be provided on the carriage or may be fixedly provided outside the carriage.
The liquid container is the cartridge in the present embodiment, but it is not limited to this. For example, it may be a liquid containing pack that contains a liquid. The accommodation section may be configured as a liquid tank and may be a type for replenishing the liquid tank with liquid.
In a case where the flow path Fr is cleaned, in the above described embodiment, the cleaning liquid cartridge is mounted on each accommodation section of the mount section 200. However, for example, an adapter (not shown) having the liquid supply section 310 (see FIG. 3) may be mounted on the accommodation section and the cleaning liquid may be supplied to the adapter from the cleaning liquid container accommodating the cleaning liquid through the ink tube.
As a use aspect in a case where one liquid ejection device 1 is used, an aspect is considered in which the pre-processing is performed on the medium in the pre-processing mode, the cleaning process is interposed, the ink cartridge is mounted, and recording is performed on the medium. In this case, as an application mode of the pre-processing liquid, the pre-processing liquid may be applied to the entire surface of the medium or the pre-processing liquid may be applied only to a region to be performed recording. When the pre-processing liquid is applied only to the region where recording is to be performed, the size of the region to be applied with the pre-processing liquid and the size of the region to be recorded may match with each other or, as described with reference to FIG. 5, the pre-processing liquid may be applied to a region slightly larger than the region to be recorded. In the case of the processing mode, the user may be able to set in advance which of the application to the entire surface and the application limited to the recording region is to be performed. When the pre-processing is performed on the medium in the pre-processing mode, it is allowable that the ejection accuracy may be lower than that in the case where recording is performed by ink, and therefore, when the pre-processing is performed on the medium in the pre-processing mode, it is also desirable to set the medium transport speed to be higher than that in the case where the recording is performed by ink.
The job data need not include the information of the liquid ejection mode. For example, since the liquid ejection mode is set in the liquid ejection device 1, the liquid ejection device 1 may print the image data included in the job data based on the set liquid ejection mode. In this case, the cartridge determination process S15 need not be executed.

### Mechanism for Suppressing Erroneous Mounting of the Liquid Container

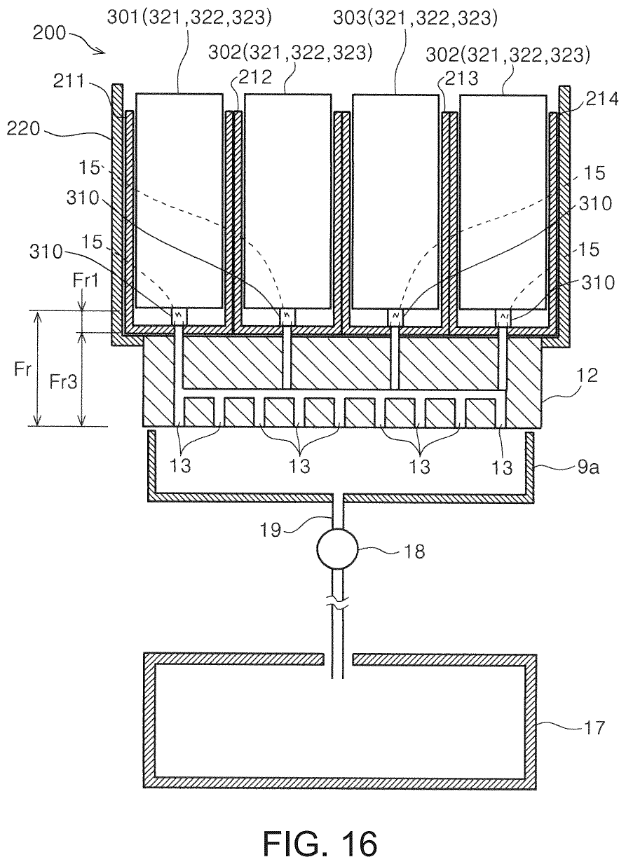

Next, with reference to FIG. 16 and the subsequent drawings, the mechanism for suppressing erroneous mounting of the liquid container, that is, the cartridge with respect to the mount section 200 will be described. As described above, when the ink and the processing liquid are mixed with each other, there is a concern that the ejection failure will occur. Therefore, it is possible to suppress defects associated with mixing of the ink and the processing liquid by providing a mechanism that suppresses an inappropriate cartridge from being mounted on the accommodation section in which the cleaning is not completed. Hereinafter, the mounting of the inappropriate cartridge in the accommodation section in which the cleaning is not completed is referred to as erroneous mounting of the cartridge.

Note that in the following description, the terms “recording liquid state”, “processing liquid state”, and “cleaning liquid state” are used to describe the state of the mount section 200.

The recording liquid state is a state in which the ink cartridge can be mounted and the processing liquid cartridge cannot be mounted. As will be described later, the mounting of the cleaning liquid cartridge may be enabled or disabled in the recording liquid state.

The processing liquid state is a state in which the ink cartridge cannot be mounted and the processing liquid cartridge can be mounted. As will be described later, the mounting of the cleaning liquid cartridge may be enabled or disabled in the processing liquid state.

The cleaning liquid state is a state in which the ink cartridge and the processing liquid cartridge cannot be mounted and the cleaning liquid cartridge can be mounted.

Note that each state of the recording liquid state, the processing liquid state, and the cleaning liquid state indicates a mode of the mount section 200 when the cartridge is attached or detached and is a concept independent of each mode described with reference to FIG. 15.

The embodiments of the mechanism for suppressing the erroneous mounting of the cartridge, which will be described hereinafter, are common in that the mount section 200 can be switched between the recording liquid state and the processing liquid state under the control of the control section 80. Accordingly, it is possible to suppress that the user erroneously mounts the processing liquid cartridge in a state where the ink cartridge should be mounted. Alternatively, it is possible to suppress that the user erroneously mounts the ink cartridge in a state in which the processing liquid cartridge should be mounted. Therefore, mixing of the ink and the processing liquid can be suppressed and good results can be obtained.

In the embodiment in which the cleaning liquid cartridge can be mounted on the mount section 200, the flow path Fr can be easily cleaned by mounting the cleaning liquid cartridge. If the flow path Fr is cleaned, it is possible to suppress different types of the liquid from being mixed and a good result is obtained.

In a configuration in which the mount section 200 has a plurality of mount regions, that is, accommodation sections, in which the ink cartridges containing the inks of mutually different colors are mounted, if the recording liquid state and the processing liquid state can be switched for each of the plurality of accommodation sections, the above described operation and effect can be obtained for each of the plurality of accommodation sections. If it is possible to switch between the recording liquid state, the processing liquid state, and the cleaning liquid state for each of the plurality of accommodation sections, it is possible to contribute to convenience of cleaning of the flow path Fr.

### First Embodiment of Mechanism for Suppressing Erroneous Mounting

Hereinafter, an embodiment based on a configuration in which the liquid ejection section 12 is the ink ejection head that is mounted on the carriage and ejects the liquid while moving in the medium width direction will be described first.

FIG. 16 is a diagram showing a modification example of the liquid ejection section 12 of FIG. 3, and the liquid ejection section 12 and the mount section 200 are provided on the carriage 220. In the present embodiment, the flow path Fr of liquid Fr includes the flow path Fr1 that is a section in the mount section 200 and the flow path Fr3 that is a section in the liquid ejection section 12 including the nozzles 13. Such a flow path Fr can also be cleaned by the cleaning liquid as described above. The carriage 220 reciprocal movements in the Y-axis direction, that is, the medium width direction, by receiving the power of a motor (not shown) controlled by the control section 80.

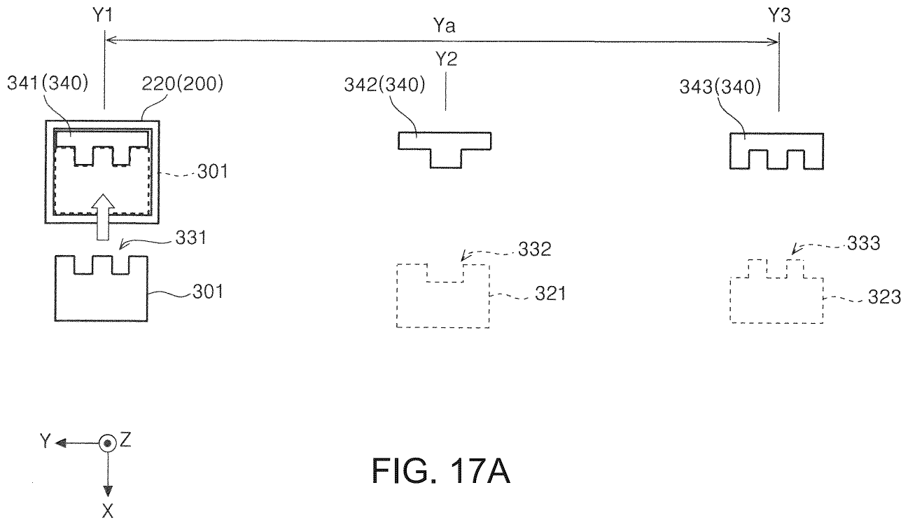

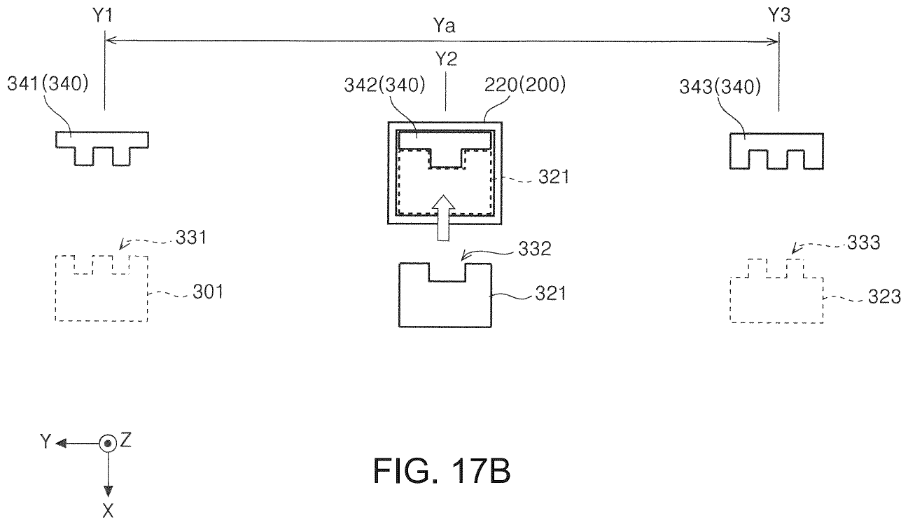

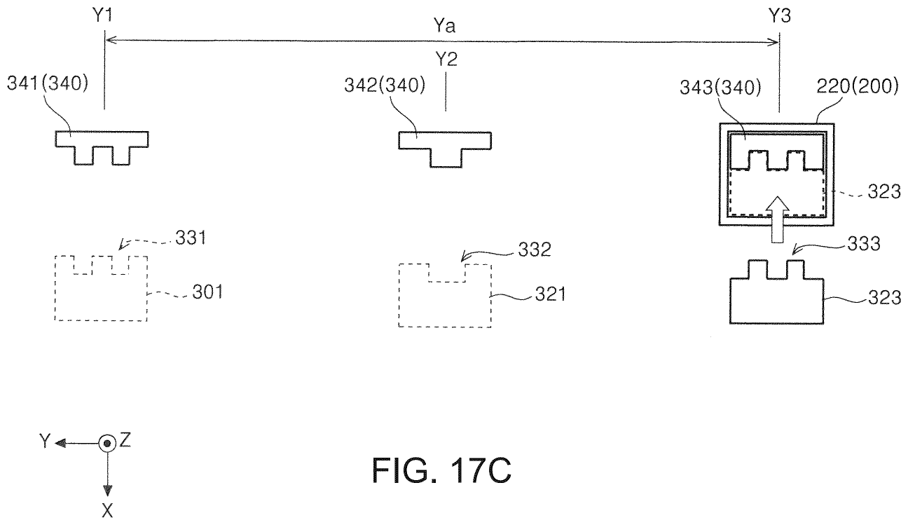

In the configuration in which the liquid ejection section 12 and the mount section 200 are provided on the carriage 220, the erroneous mounting of the cartridge can be suppressed by the configuration shown in FIG. 17A to FIG. 17C. Note that in FIG. 17A to FIG. 17C, for convenience of description, it is assumed that one cartridge is mounted on the mount section 200, and the ink cartridge 301 containing black ink is employed as an example of the ink cartridge. The pre-processing liquid cartridge 321 is employed as an example of the processing liquid cartridge. However, it is not limited to this, and a plurality of cartridges may be mountable on the mount section 200 and an example of the processing liquid cartridge may be the post-processing liquid cartridge 322. When the pre-processing liquid cartridge 321 is used in the embodiment described below, all of them may be the post-processing liquid cartridge 322.

In FIG. 17A to FIG. 17C, reference symbol 340 indicates state forming sections provided on a movement region of the carriage 220. The state forming sections 340 form each state of the recording liquid state, the accommodated liquid state, and the cleaning liquid state.

Specifically, the state forming sections 340 include a first limiting section 341, a second limiting section 342, and a third limiting section 343.

The first limiting section 341 is positioned above the mount section 200 when the carriage 220 is positioned at a first position Y1 in the movement region Ya of the carriage 220.

The second limiting section 342 is positioned above the mount section 200 when the carriage 220 is positioned at a second position Y2 in the movement region Ya of the carriage 220.

The third limiting section 343 is positioned above the mount section 200 when the carriage 220 is positioned at a third position Y3 in the movement region Ya of the carriage 220.

FIG. 17A shows the recording liquid state. Note that in FIG. 17A, the pre-processing liquid cartridge 321 and the cleaning liquid cartridge 323 are indicated by dashed line for reference.

In the recording liquid state, the carriage 220 is positioned at the first position Y1. The ink cartridge 301 can be mounted on the mount section 200 by dropping it from above. However, in FIG. 17A, for convenience of showing, the ink cartridge 301 before mounting is shifted in the +X direction and is indicated by solid line.

The ink cartridge 301 is provided with an ink fitting section 331. The ink fitting section 331 and the first limiting section 341 have a protrusion-recess shape that fit each other. The ink cartridge 301 mounted on the mount section 200 is indicated by dashed line.

The pre-processing liquid cartridge 321 is also provided with a processing liquid fitting section 332, but the protrusion-recess of the processing liquid fitting section 332 has a shape that cannot be fitted into the protrusion-recess of the first limiting section 341. Therefore, in the case of the recording liquid state, the ink cartridge 301 can be mounted on the mount section 200, but the pre-processing liquid cartridge 321 cannot be mounted.

Note that the cleaning liquid cartridge 323 is also provided with a cleaning liquid fitting section 333. In the present embodiment, the protrusion-recess of the cleaning liquid fitting section 333 also has a shape that cannot be fitted in the protrusion-recess of the first limiting section 341. Therefore, in the present embodiment, in the case of the recording liquid state, the cleaning liquid cartridge 323 cannot be mounted on the mount section 200.

FIG. 17B shows the processing liquid state. Note that in FIG. 17B, the ink cartridge 301 and the cleaning liquid cartridge 323 are indicated by dashed line for reference.

In the processing liquid state, the carriage 220 is positioned at the second position Y2. The pre-processing liquid cartridge 321 can be mounted to the mount section 200 by dropping from above. However, in FIG. 17B, for convenience of showing, the pre-processing liquid cartridge 321 before mounting is shifted in the +X direction and is indicated by solid line.

The pre-processing liquid cartridge 321 is provided with a processing liquid fitting section 332. The processing liquid fitting section 332 and the second limiting section 342 have a protrusion-recess shape that fit each other. The pre-processing liquid cartridge 321 mounted on the mount section 200 is shown by dashed line.

Here, the protrusion-recess of the ink fitting section 331 of the ink cartridge 301 has a shape that cannot be fitted in the protrusion-recess of the second limiting section 342. Therefore, in the case of the processing liquid state, the pre-processing liquid cartridge 321 can be mounted on the mount section 200, but the ink cartridge 301 cannot be mounted.

Note that the protrusion-recess of the cleaning liquid fitting section 333 also has a shape that cannot be fitted in the protrusion-recess of the second limiting section 342. Therefore, in the present embodiment, in the case of the processing liquid state, the cleaning liquid cartridge 323 cannot be mounted on the mount section 200.

FIG. 17C shows the cleaning liquid state. Note that in FIG. 17C, the ink cartridge 301 and the pre-processing liquid cartridge 321 are shown by dashed line for reference.

In the cleaning liquid state, the carriage 220 is positioned at the third position Y3. The cleaning liquid cartridge 323 can be mounted to the mount section 200 by dropping from above. However, in FIG. 17C, for convenience of showing, the cleaning liquid cartridge 323 before mounting is shifted in the +X direction and is indicated by solid line.

The cleaning liquid fitting section 333 and the third limiting section 343 of the cleaning liquid cartridge 323 have protrusion-recess shapes that fit each other. The cleaning liquid cartridge 323 mounted on the mount section 200 is shown by dashed line.

Here, the protrusion-recess of the ink fitting section 331 of the ink cartridge 301 and the protrusion-recess of the processing liquid fitting section 332 of the pre-processing liquid cartridge 321 have a shape that cannot be fitted in the protrusion-recess of the third limiting section 343. Therefore, in the cleaning liquid state, the cleaning liquid cartridge 323 can be mounted on the mount section 200, but the ink cartridge 301 and the pre-processing liquid cartridge 321 cannot be mounted.

In the present embodiment, as described above, in the recording liquid state, the cleaning liquid cartridge 323 cannot be mounted in addition to the pre-processing liquid cartridge 321. In the processing liquid state, the cleaning liquid cartridge 323 cannot be mounted in addition to the ink cartridge 301. In the cleaning liquid state, the ink cartridge 301 and the pre-processing liquid cartridge 321 cannot be mounted.

In such a configuration, by setting the cleaning liquid state, the ink cartridge 301 and the pre-processing liquid cartridge 321 cannot be mounted, and it is possible to prompt the user to clean the flow path Fr.

Note that on the premise of the configuration including the first limiting section 341 and the second limiting section 342, in the present embodiment, the first limiting section 341 does not interfere with the ink cartridge 301 and interferes with the pre-processing liquid cartridge 321. The second limiting section 342 does not interfere with the pre-processing liquid cartridge 321 and interferes with the ink cartridge 301. By the first limiting section 341, the second limiting section 342, and the moving of the carriage 220, a required state, that is, the recording liquid state and the processing liquid state, can be formed.

In the present embodiment, the third limiting section 343 is further provided, and the first limiting section 341 does not interfere with the ink cartridge 301 and interferes with the pre-processing liquid cartridge 321 and the cleaning liquid cartridge 323. The second limiting section 342 does not interfere with the pre-processing liquid cartridge 321 and interferes with the ink cartridge 301 and the cleaning liquid cartridge 323. The third limiting section 343 does not interfere with the cleaning liquid cartridge 323 and interferes with the ink cartridge 301 and the pre-processing liquid cartridge 321. By the first limiting section 341, the second limiting section 342, and the third limiting section 343, and the moving of the carriage 220, the necessary states, that is, the recording liquid state, the processing liquid state, and the cleaning liquid state can be formed.

Note that as a modification, in the recording liquid state, the contained liquid state and the cleaning liquid state, the state forming sections 340 may be configured to allow the cartridge to be removed regardless of the type of the cartridge.

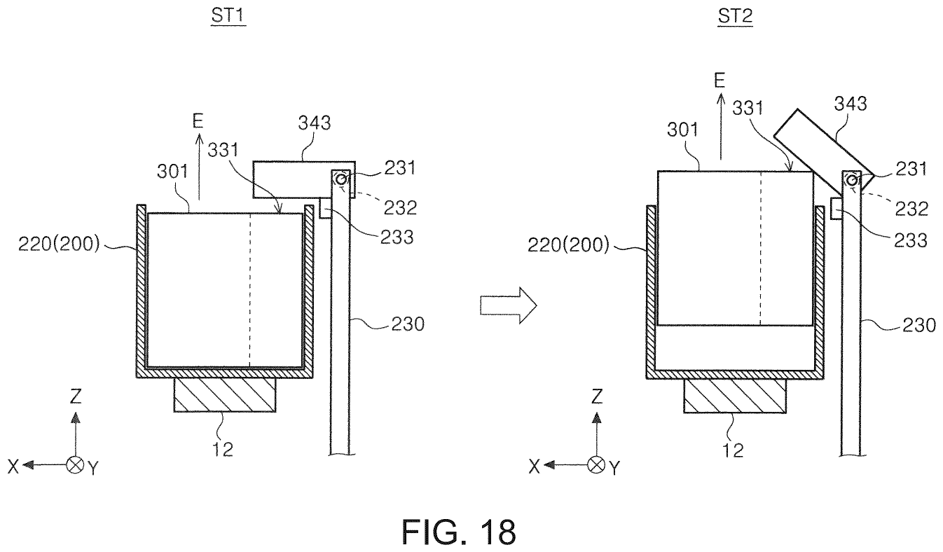

FIG. 18 is an example of such a modification, and FIG. 18 shows, as an example, a state in which the carriage 220 is positioned at the third position Y3, the ink cartridge 301 is mounted on the mount section 200, and the third limiting section 343 is positioned at the upper portion of the mount section 200.

The third limiting section 343 is provided pivotably with respect to a shaft 231 provided on a frame 230. The shaft 231 is provided with a torsion spring 232, and the third limiting section 343 is pressed by the torsion spring 232 in a downward direction, more specifically, in a direction in which a state ST1 of FIG. 18 is taken.

The frame 230 is provided with a restricting section 233, the third limiting section 343 is in contact with the restricting section 233, the movement in the downward direction is restricted, it is possible to maintain the state ST1 of FIG. 18. However, by contacting the third limiting section 343 to the restricting section 233, it is in a restricted state that further downward movement from the state ST1. Therefore, the function of suppressing the mounting of the inappropriate cartridge is not impaired.

In the state ST1 of FIG. 18, since the ink fitting section 331 of the ink cartridge 301 does not match the shape of the third limiting section 343 as described above, if the third limiting section 343 is fixed, the ink cartridge 301 cannot be removed in a removal direction E.

However, in the present embodiment, the third limiting section 343 can pivot against the pressing force of the torsion spring 232 and move upward. Therefore, as shown by the change from the state ST1 to a state ST2 in FIG. 18, the ink cartridge 301 can be removed in the removal direction E.

Note that although FIG. 18 shows an example of the third limiting section 343, it is assumed that the first limiting section 341 and the second limiting section 342 have the same configuration, and the cartridge can be made able to remove regardless of the state of the mount section 200 and regardless of the type of the cartridge.

In this manner, usability is improved in a configuration in which the cartridge can be removed regardless of the state of the mount section 200 or regardless of the type of the cartridge.

For example, in the case where each limiting section is fixed, when attempting to replace the ink cartridge with the cleaning liquid cartridge, the ink cartridge is removed while in a state in which the carriage 220 is in the first position Y1, and then the operation panel 86 inputs the ink cartridge removal. Then, when the control section 80 moves the carriage 220 to the third position Y3 in response thereto, the ink cartridge can be removed. In this manner, when the limiting portions are fixed, the labor of the user is increased, but as in the present embodiment, the usability is improved by the configuration that enables removal of the cartridge regardless of the state of the mount section 200 and regardless of the type of the cartridge.

Such a configuration can be said to be a configuration in which the restricting sections restrict displacement in the mounting direction in which the cartridge is mounted, but do not restrict displacement in the removal direction in which the cartridge is removed.

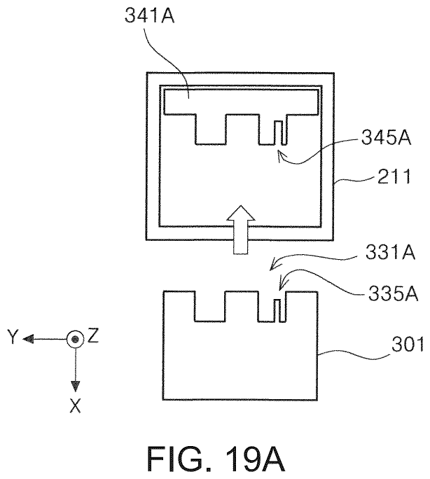

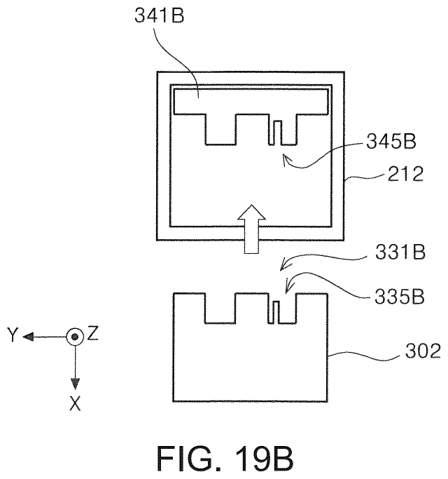

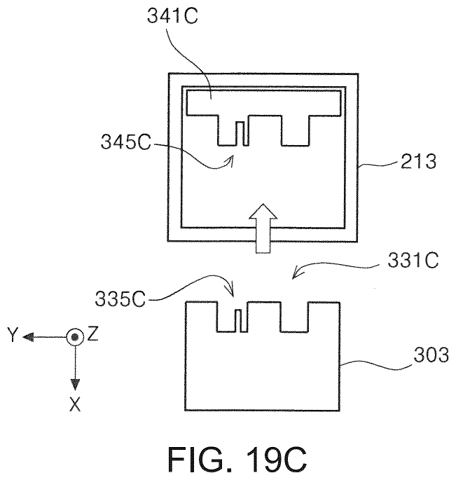

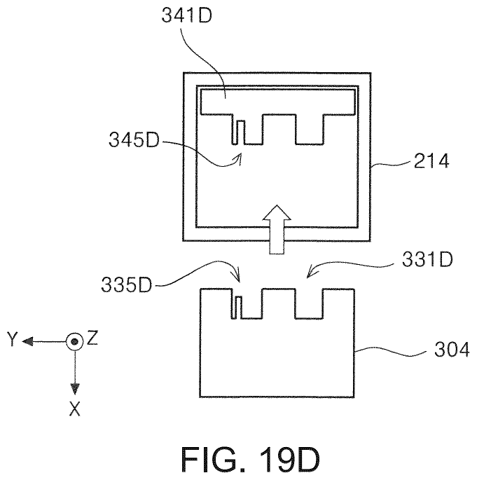

Note that the first limiting section 341 and the ink fitting section 331 described above can be made unique according to the color of the ink. FIG. 19A to FIG. 19D are examples of such modifications. Note that in FIG. 19A to FIG. 19D, the accommodation sections (211, 212, 213, and 214) for accommodating the ink cartridges are separately shown for convenience of description, but the accommodation sections are integrally provided as shown in FIG. 16.

FIG. 19A shows a case of the ink cartridge 301 that stores the black ink, in which the ink cartridge 301 is provided with an ink fitting section 331A and can be fitted to a protrusion-recess of the first limiting section 341A. Here, the ink fitting section 331A is formed with a unique section 335A having a unique shape, and the first limiting section 341A is formed with a unique section 345A that can be fitted to the unique section 335A. Therefore, ink fitting sections (to be described later, 331B, 331C, and 331D) of the other colors cannot be fitted to the first limiting section 341A.

FIG. 19B shows a case of the ink cartridge 302 that stores the magenta ink, in which the ink cartridge 302 is provided with an ink fitting section 331B and can be fitted to a protrusion-recess of the first limiting section 341B. Here, the ink fitting section 331B is formed with a unique section 335B having a unique shape, and the first limiting section 341B is formed with a unique section 345B that can be fitted with the unique section 335B. Therefore, the ink fitting sections (331A, 331C, and 331D) of the other colors cannot be fitted to the first limiting section 341B.

FIG. 19C shows a case of the ink cartridge 303 that stores the cyan ink, in which the ink cartridge 303 is provided with an ink fitting section 331C and can be fitted to a protrusion-recess of the first limiting section 341C. Here, the ink fitting section 331C is formed with a unique section 335C having a unique shape, and the first limiting section 341C is formed with a unique section 345C that can be fitted with the unique section 335C. Therefore, the ink fitting sections (331A, 331B, and 331D) of the other colors cannot be fitted to the first limiting section 341C.

FIG. 19D shows a case of the ink cartridge 304 that stores the yellow ink, in which the ink cartridge 304 is provided with an ink fitting section 331D and can be fitted to the protrusion-recess of the first limiting section 341D. Here, the ink fitting section 331D is formed with a unique section 335D having a unique shape, and the first limiting section 341D is formed with a unique section 345D that can be fitted with the unique section 335D. Therefore, the ink fitting sections (331A, 331B, and 331C) of the other colors cannot be fitted to the first limiting section 341D.

In such a configuration, when one of the first accommodation section 211, the second accommodation section 212, the third accommodation section 213, and the fourth accommodation section 214 is set as the first mount region and the other one is set as the second mount region, it can be said that both the first mount region and the second mount region are configured to be switchable between the recording liquid state and the processing liquid state. Then, one of black, magenta, cyan, and yellow is used as the first color, an other one is used as the second color, the ink cartridge containing the ink of the first color is used as the first ink cartridge, and the ink cartridge containing the ink of the second color is used as the second ink cartridge.

The above configuration can be said to be a configuration in which the first ink cartridge cannot be mounted on the second mount region, and the second ink cartridge cannot be mounted on the first mount region.

According to such a configuration, mixing of the inks of different colors can be avoided, and mixing of the ink and the processing liquid can also be avoided.

Note that as a modification of the above embodiment, a configuration in which the cleaning liquid fitting section 333 of the cleaning liquid cartridge 323 is deleted and the cleaning liquid cartridge 323 does not interfere with the first limiting section 341 and the second limiting section 342 can be employed. In this case, the third limiting section 343 may not be provided. According to such a configuration, the cleaning liquid cartridge 323 can be mounted on the mount section 200 even when the carriage 220 is positioned at the first position Y1 and the second position Y2, that is, even in the recording liquid state and the processing liquid state. As a result, the number of operations for mounting the cleaning liquid cartridge 323 is reduced, and usability is improved.

In addition, in a configuration in which the mount section 200 includes the plurality of accommodation sections, the cleaning liquid cartridge 323 may be mounted together with other cartridges of different types, such as in the ink mode (single color), pre-processing mode, and post-processing mode shown in FIG. 15. Even in such a case, if the cleaning liquid cartridge 323 can be mounted regardless of the state of the mount section 200, usability is improved.

### Second embodiment of Mechanism for Suppressing Erroneous Mounting

Hereinafter, a description will be given on the assumption that the liquid ejection section 12 is a line head having the plurality of nozzles 13 for ejecting the liquid over the entire region in the medium width direction. The embodiment described below can be applied to a configuration in which the liquid ejection section 12 is provided on the carriage 220.

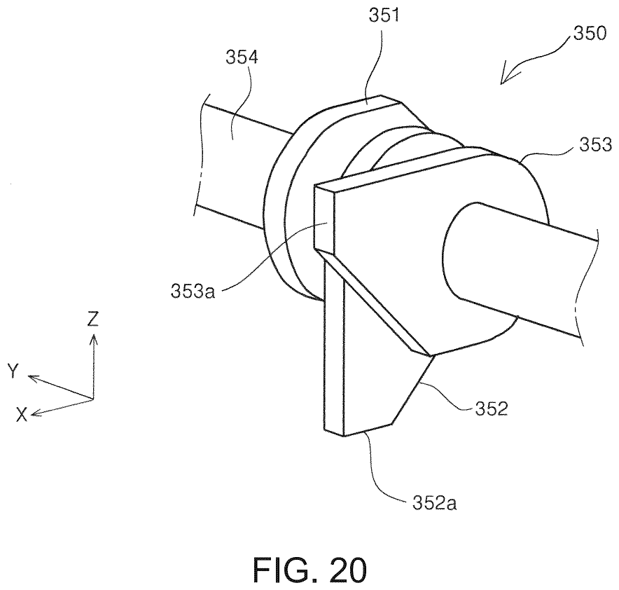

FIG. 20 shows a state forming section 350 according to the present embodiment. Reference symbol 351 indicates a first limiting section, reference symbol 352 indicates a second limiting section, and reference symbol 353 indicates a third limiting section. The state forming section 350 forms the states of the recording liquid state, the accommodated liquid state, and the cleaning liquid state in the same manner as the state forming section 340 described above. One of the differences between the state forming section 350 according to the present embodiment and the above described state forming section 340 is that the limiting sections are provided adjacent to each other at one place and operate.

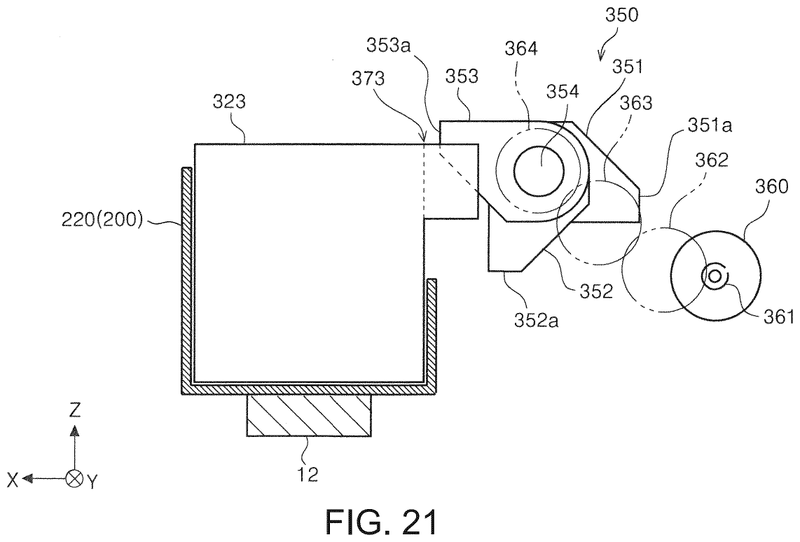

Specifically, the first limiting section 351, the second limiting section 352, and the third limiting section 353 are plate-shaped bodies and are provided at intervals along the axial direction with respect to a shaft 354. The shaft 354 is a shaft whose axial line is along the Y-axis direction. Each limiting section has a shape such that a part thereof in the circumferential direction protrudes in a radial direction. Specifically, the first limiting section 351 has a first protrusion section 351a (see FIG. 21) protruding in the radial direction. The second limiting section 352 has a second protrusion section 352a protruding in the radial direction. The third limiting section 353 has a third protrusion section 353a protruding in the radial direction.

Each protrusion section of each limiting section is advanced to the mount section 200 by rotation of the shaft 354, that is, it can be advanced to a position where it can be engaged with the cartridge. Each protrusion section of each limiting section is retreated from the mount section 200 by rotation of the shaft 354, that is, it can be retreated to a position where it cannot be engaged with the cartridge.

In the rotating direction of the shaft 354, the protruding phases of the protrusion sections are shifted and the plural protrusion section is not simultaneously advanced to a position where they can be engaged with the cartridge.

Each protrusion section of each limiting section is an example of an advance and retreat section that can advance and retreat toward the mount section 200.

As shown in FIG. 21, power is transmitted to the shaft 354 from a motor 360 controlled by the control section 80. Reference symbols 361, 362, 363, and 364 are gears that transmit power from the motor 360 to the shaft 354. In order to avoid complications of the drawing, the gears 362, 363, and 364 are shown by imaginary lines. Note that the present embodiment has been configured to provide the dedicated motor 360, the motor 360 may drive other driven sections. For example, the motor 360 may drive at least one roller.

The motor 360 is provided with a rotary encoder and a home detection unit (not shown), and thus the control section 80 can grasp the phase of each limiting section, that is, the protruding state of each protrusion section.

Note that FIG. 21 shows the cleaning liquid state as an example, and a cleaning liquid cartridge 323 is mounted on the mount section 200. Reference symbol 373 indicates a cleaning liquid fitting section (to be described later).

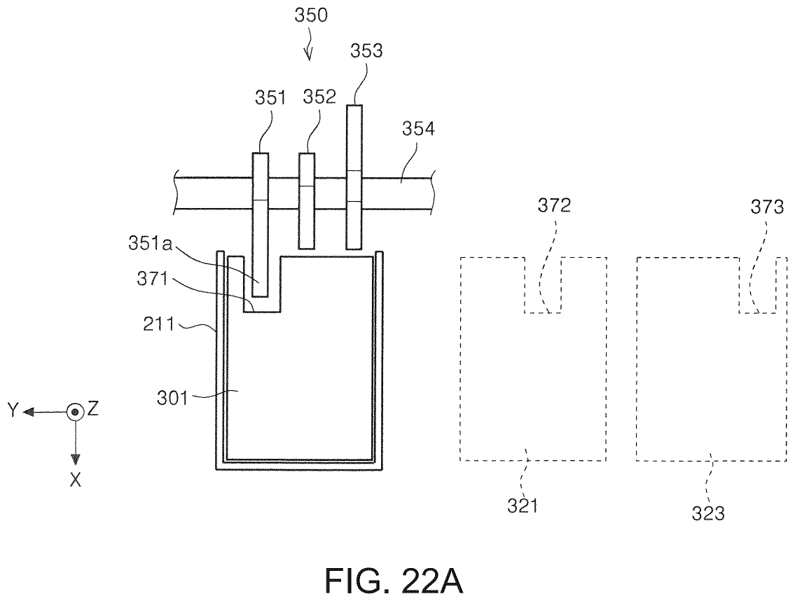

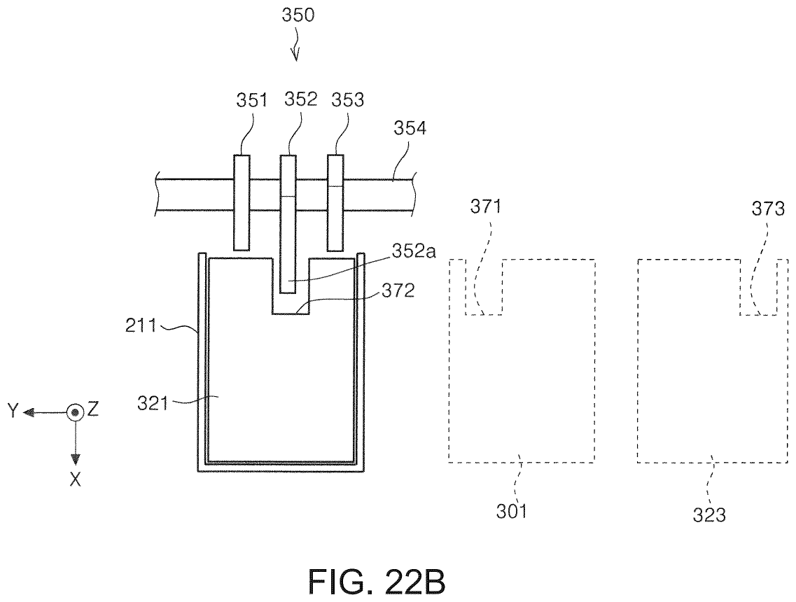

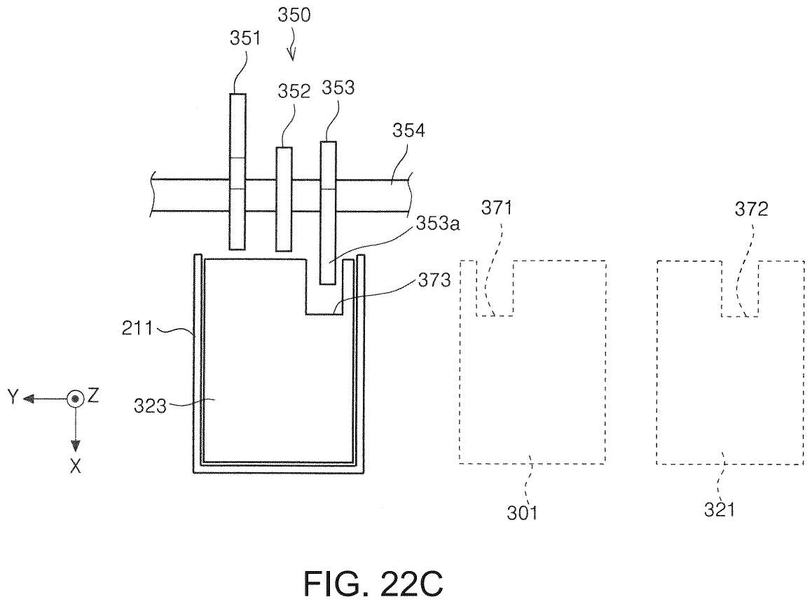

Hereinafter, with reference to FIG. 22A, FIG. 22B, and FIG. 22C, the states of the recording liquid state, the accommodated liquid state, and the cleaning liquid state will be specifically described. Note that in FIG. 22A, FIG. 22B, and FIG. 22C, for convenience of description, the first accommodation section 211 among the accommodation sections for accommodating the cartridges is shown as a representative example, and the other accommodation sections (212, 213, and 214) and the state forming sections 350 corresponding thereto are omitted.

FIG. 22A shows the recording liquid state. An ink fitting section 371 is formed on the ink cartridge 301. Note that in FIG. 22A, the pre-processing liquid cartridge 321 and the cleaning liquid cartridge 323 are indicated by dashed line for reference. A processing liquid fitting section 372 is formed on the pre-processing liquid cartridge 321 and a cleaning liquid fitting section 373 is formed on the cleaning liquid cartridge 323. However, in the axial direction of the shaft 354, that is, in the Y-axis direction, these positions of the ink fitting section 371, the processing liquid fitting section 372, and the cleaning liquid fitting section 373 are shifted.

In the recording liquid state, only the first protrusion section 351a of the first limiting section 351 protrudes toward the cartridge side, and the ink fitting section 371 of the ink cartridge 301 can receive the first protrusion section 351a. Therefore, the ink cartridge 301 can be mounted on the first accommodation section 211.

However, the processing liquid fitting section 372 of the pre-processing liquid cartridge 321 and the cleaning liquid fitting section 373 of the cleaning liquid cartridge 323 are not positioned to receive the first protrusion section 351a. Therefore, in the recording liquid state, the pre-processing liquid cartridge 321 and the cleaning liquid cartridge 323 cannot be mounted on the first accommodation section 211.

The same applies to FIG. 22B. That is, in the processing liquid state shown in FIG. 22B, only the second protrusion section 352a of the second limiting section 352 protrudes toward the cartridge side, and the processing liquid fitting section 372 of the pre-processing liquid cartridge 321 can receive the second protrusion section 352a. Therefore, the pre-processing liquid cartridge 321 can be mounted on the first accommodation section 211.

However, the ink fitting section 371 of the ink cartridge 301 and the cleaning liquid fitting section 373 of the cleaning liquid cartridge 323 are not positioned to receive the second protrusion section 352a. Therefore, in the processing liquid state, the ink cartridge 301 and the cleaning liquid cartridge 323 cannot be mounted on the first accommodation section 211.

The same applies to FIG. 22C. That is, in the cleaning liquid state shown in FIG. 22C, only the third protrusion section 353a of the third limiting section 353 protrudes toward the cartridge side, and the cleaning liquid fitting section 373 of the cleaning liquid cartridge 323 can receive the third protrusion section 353a. Therefore, the cleaning liquid cartridge 323 can be mounted on the first accommodation section 211.

However, the ink fitting section 371 of the ink cartridge 301 and the processing liquid fitting section 372 of the pre-processing liquid cartridge 321 are not positioned to receive the third protrusion section 353a. Therefore, in the cleaning liquid state, the ink cartridge 301 and the pre-processing liquid cartridge 321 cannot be mounted on the first accommodation section 211.

As described above, the present embodiment has the protrusion sections which are examples of an advance and retreat section that can advance and retreat toward the mount section 200. Each protrusion section fits with the ink fitting section 371 and interferes with the processing liquid fitting section 372 in the recording state. In the processing liquid state, it interferes with the ink fitting section 371 and fits the processing liquid fitting section 372.

According to such an embodiment, each state of the recording liquid state and the processing liquid state can be easily formed by each protrusion section.

Note that in the present embodiment, the protrusion sections advance and retreat toward the mount section 200 by the rotation of the shaft 354, but a configuration may be adopted in which the protrusion sections advance and retreat toward the mount section 200 by the linear movement of the protrusion sections.

Also in the present embodiment, as described above, in the recording liquid state, in addition to the pre-processing liquid cartridge 321, the cleaning liquid cartridge 323 cannot be mounted. In the processing liquid state, the cleaning liquid cartridge 323 cannot be mounted in addition to the ink cartridge 301. In the cleaning liquid state, the ink cartridge 301 and the pre-processing liquid cartridge 321 cannot be mounted.

In such a configuration, by setting the cleaning liquid state, the ink cartridge 301 and the pre-processing liquid cartridge 321 cannot be mounted, and it is possible to prompt the user to clean the flow path Fr.

Note that on the premise of the configuration including the first limiting section 351 and the second limiting section 352, in the present embodiment, the first limiting section 351 does not interfere with the ink cartridge 301 and interferes with the pre-processing liquid cartridge 321. The second limiting section 352 does not interfere with the pre-processing liquid cartridge 321 and interferes with the ink cartridge 301. By the operation of the first limiting section 351 and the second limiting section 352, a required state, that is, the recording liquid state and the processing liquid state, can be formed.

In the present embodiment, the third limiting section 353 is further provided, and the first limiting section 351 does not interfere with the ink cartridge 301 and interferes with the pre-processing liquid cartridge 321 and the cleaning liquid cartridge 323. The second limiting section 352 does not interfere with the pre-processing liquid cartridge 321 and interferes with the ink cartridge 301 and the cleaning liquid cartridge 323. The third limiting section 353 does not interfere with the cleaning liquid cartridge 323 and interferes with the ink cartridge 301 and the pre-processing liquid cartridge 321. By the operation of the first limiting section 351, the second limiting section 352, and the third limiting section 353, a required state, that is, the recording liquid state, the processing liquid state, and the cleaning liquid state can be formed.

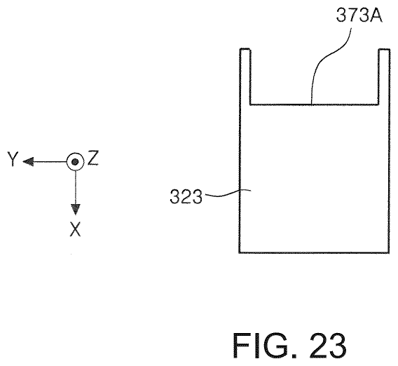

As a modification, the cleaning liquid fitting section 373 of the cleaning liquid cartridge 323 may be enlarged in the Y-axis direction as the cleaning liquid fitting section 373A shown in FIG. 23 so as not to interfere with the first protrusion section 351a of the first limiting section 351 and the second protrusion section 352a of the second limiting section 352. In this case, the third limiting section 353 may not be provided.

According to such a configuration, the cleaning liquid cartridge 323 can be mounted on the mount section 200 even in the recording liquid state and the processing liquid state. As a result, the number of operations for mounting the cleaning liquid cartridge 323 is reduced, and usability is improved.

In addition, in a configuration in which the mount section 200 includes the plurality of accommodation sections, the cleaning liquid cartridge 323 may be mounted together with other cartridges of different types, such as in the ink mode (single color), pre-processing mode, and post-processing mode shown in FIG. 15. Even in such a case, the cleaning liquid cartridge 323 can be mounted on either the recording liquid state or the processing liquid state, and usability is improved.

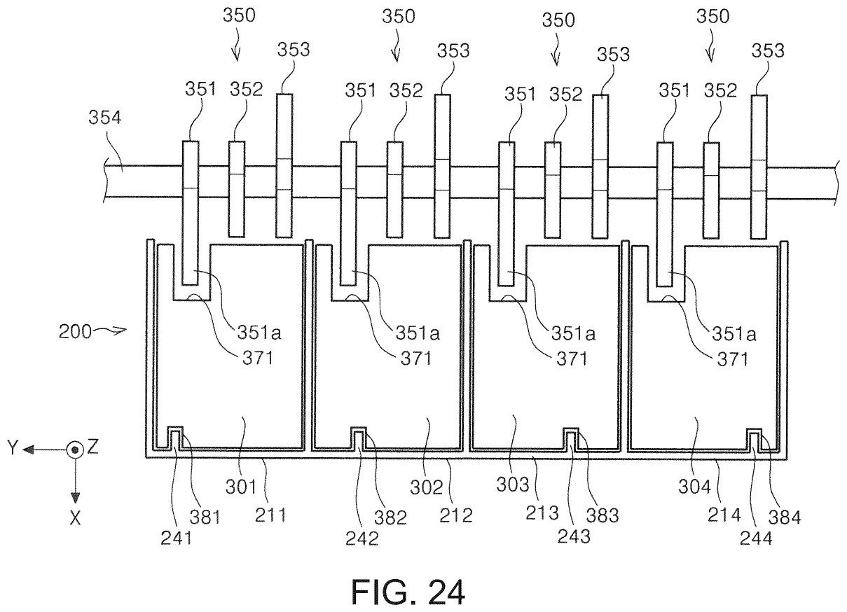

Next, with reference to FIG. 24, a configuration further including an erroneous mounting suppressing mechanism for suppressing the mounting of the ink cartridge of the inappropriate color will be described.

FIG. 24 shows the recording liquid state, and the black ink cartridge 301 is mounted on the first accommodation section 211 and the magenta ink cartridge 302 is mounted on the second accommodation section 212. The cyan ink cartridge 303 is mounted on the third accommodation section 213, and the yellow ink cartridge 304 is mounted on the fourth accommodation section 214.

Here, a color identification section 381 is formed in the black ink cartridge 301. An erroneous mounting suppressing section 241 is formed in the first accommodation section 211. The color identification section 381 and the erroneous mounting suppressing section 241 can be fitted.

A color identification section 382 is formed in the magenta ink cartridge 302. An erroneous mounting suppressing section 242 is formed in the second accommodation section 212. The color identification section 382 and the erroneous mounting suppressing section 242 can be fitted together.

A color identification section 383 is formed in the cyan ink cartridge 303. An erroneous mounting suppressing section 243 is formed in the third accommodation section 213. The color identification section 383 and the erroneous mounting suppressing section 243 can be fitted.

A color identification section 384 is formed in the yellow ink cartridge 304. An erroneous mounting suppressing section 244 is formed in the fourth accommodation section 214. The color identification section 384 and the erroneous mounting suppressing section 244 can be fitted together.

Note that in the present embodiment, the color identification section is formed as the recess section, and the erroneous mounting prevention section is formed as the protrusion section, but the reverse may be possible.

Here, the positions in the Y-axis direction of the pair of the color identification section 381 and the erroneous mounting suppressing section 241, the pair of the color identification section 382 and the erroneous mounting suppressing section 242, the pair of the color identification section 383 and the erroneous mounting suppressing section 243, and the pair of the color identification section 384 and the erroneous mounting suppressing section 244 are different from each other.

Accordingly, for example, the black ink cartridge 301 can be mounted only on the first accommodation section 211, and cannot be mounted on other accommodation sections due to interference with the erroneous mounting suppressing sections 242, 243, and 244. The same applies to the ink cartridges of other colors.

In such a configuration, when one of the first accommodation section 211, the second accommodation section 212, the third accommodation section 213, and the fourth accommodation section 214 is set as the first mount region and another one is set as the second mount region, it can be said that both the first mount region and the second mount region are configured to be switchable between the recording liquid state and the processing liquid state. Then, one of black, magenta, cyan, and yellow is used as the first color, an other one is used as the second color, the ink cartridge containing the ink of the first color is used as the first ink cartridge, and the ink cartridge containing the ink of the second color is used as the second ink cartridge.

It can be said that the above configuration is a configuration having a first erroneous mounting suppressing section that fits with the color identification section of the first ink cartridge and interferes with the second ink cartridge in the first mount region and a second erroneous mounting suppressing section that interferes with the first ink cartridge and fits with the color identification section of the second ink cartridge in the second mount region.

According to such a configuration, mixing of the inks of different colors can be avoided, and mixing of the ink and the processing liquid can also be avoided.

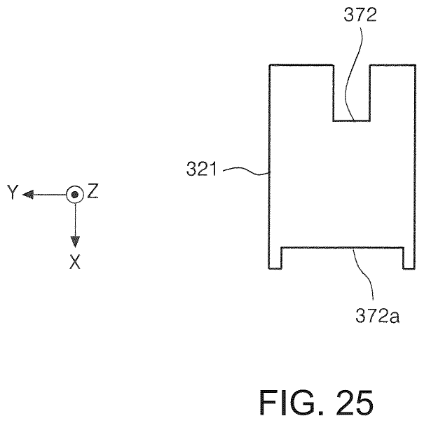

Note that when the configuration shown in FIG. 24 is employed, the pre-processing liquid cartridge 321 may be configured as shown in FIG. 25. In the pre-processing liquid cartridge 321 shown in FIG. 25, a recess section 372a is formed so as not to interfere with all of the above described erroneous mounting suppressing sections 241, 242, 243, and 244. That is, the pre-processing liquid cartridge 321 does not interfere with the first erroneous mounting suppressing section and the second erroneous mounting suppressing section.

Accordingly, in the liquid ejection device 1 capable of recording with inks of different colors, mixing of inks of different colors can be avoided and mixing of ink and the processing liquid can also be avoided.

Since the pre-processing liquid cartridge 321 does not interfere with the first erroneous mounting suppressing section and the second erroneous mounting suppressing section, it is possible to suppress the inhibition of the mounting of the pre-processing liquid cartridge 321 while avoiding mixing of inks of different colors.

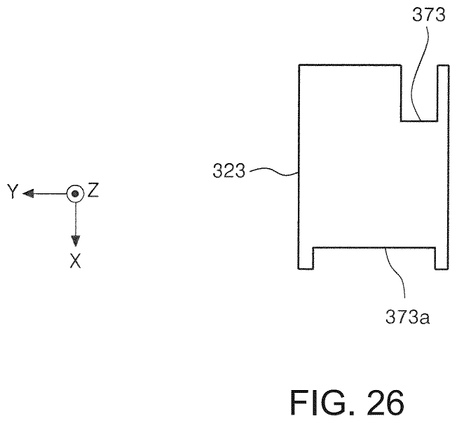

Note that the cleaning liquid cartridge 323 can similarly be prevented from interfering with the first erroneous mounting suppressing section and second erroneous mounting suppressing section. FIG. 26 is an example thereof, and in the cleaning liquid cartridge 323 shown in FIG. 26, a recess section 373a is formed so as not to interfere with all of the above described erroneous mounting suppressing sections 241, 242, 243, and 244. That is, the cleaning liquid cartridge 323 does not interfere with the first erroneous mounting suppressing section and the second erroneous mounting suppressing section.

Accordingly, in the liquid ejection device 1 capable of recording with inks of different colors, mixing of inks of different colors can be avoided and mixing of ink and the processing liquid or the cleaning liquid can also be avoided.

Since the processing liquid cartridge and the cleaning liquid cartridge does not interfere with the first erroneous mounting suppressing section and the second erroneous mounting suppressing section, it is possible to suppress inhibition of the mounting of the processing liquid cartridge or the cleaning liquid cartridge while avoiding mixing of the inks of different colors.

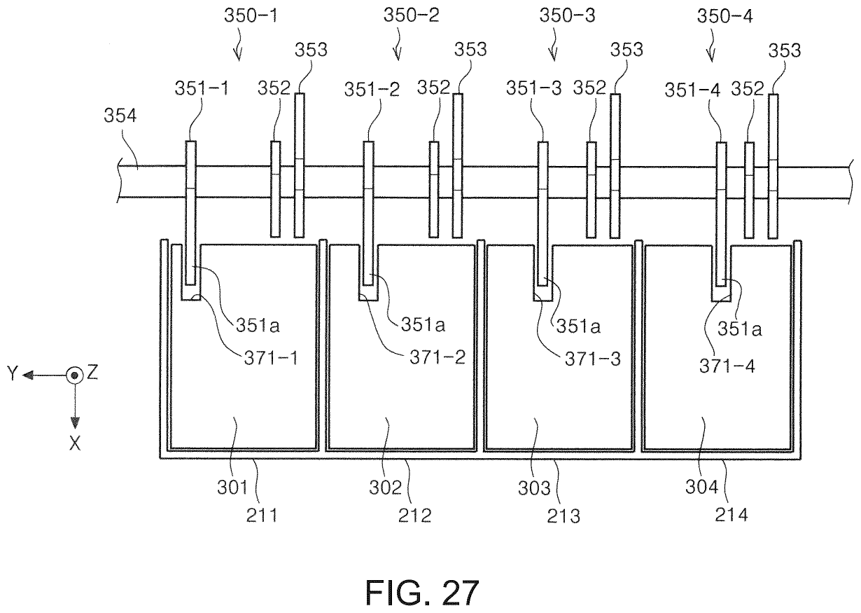

Next, with reference to FIG. 27, an erroneous mounting suppressing mechanism will be described that suppresses mounting of an ink cartridge of an inappropriate color by changing the arrangement of the first limiting section 351.

In FIG. 27, the first limiting sections 351 corresponding to the accommodation sections are provided at different positions in the Y-axis direction. Reference symbol 350-1 indicates the state forming section corresponding to the first accommodation section 211, and reference symbol 351-1 indicates the first limiting section corresponding to the first accommodation section 211. Reference symbol 350-2 indicates the state forming section corresponding to the second accommodation section 212, and reference symbol 351-2 indicates the second limiting section corresponding to the second accommodation section 212. Reference symbol 350-3 indicates the state forming section corresponding to the third accommodation section 213, and reference symbol 351-3 indicates the third limiting section corresponding to the third accommodation section 213. Reference symbol 350-4 indicates the state forming section corresponding to the fourth accommodation section 214, and reference symbol 351-4 indicates the fourth limiting section corresponding to the fourth accommodation section 214.

The first limiting sections 351-1, 351-2, 351-3, and 351-4 are disposed so as to have different distances from the second limiting section 352 in the Y-axis direction.

An ink fitting section 371-1 is formed in the black ink cartridge 301. An ink fitting section 371-2 is formed in the magenta ink cartridge 302. An ink fitting section 371-3 is formed in the cyan ink cartridge 303. An ink fitting section 371-4 is formed in the yellow ink cartridge 304.

Each ink fitting section has a different position in the Y-axis direction so as to be able to receive the corresponding first protrusion section 351a.

Accordingly, for example, the black ink cartridge 301 can be mounted only on the first accommodation section 211, and when it mounts on another accommodation section, it interferes with the first protrusion section 351a corresponding to the other accommodation section and cannot be mounted. The same applies to the ink cartridges of other colors.

Even by such a configuration, mixing of inks of different colors can be avoided and mixing of ink and the processing liquid or the cleaning liquid can also be avoided.

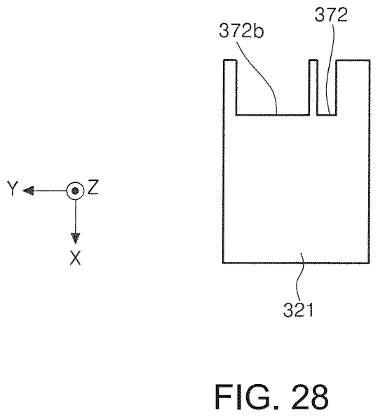

Note that in such a configuration, the pre-processing liquid cartridge 321 may be configured as shown in FIG. 28. In the pre-processing liquid cartridge 321 shown in FIG. 28, a recess section 372b is formed so as to avoid interference with all of the four first protrusion sections 351a.

Accordingly, it is possible to suppress the inhibition of the mounting of the pre-processing liquid cartridge 321 while avoiding mixing of inks of different colors.

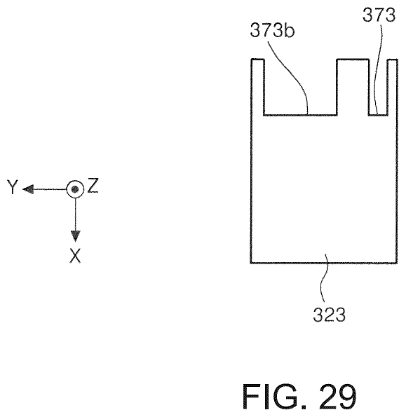

Similarly in the cleaning liquid cartridge 323, as shown in FIG. 29, if the recess section 373b is formed so as to avoid interference with all of the four first protrusion sections 351a, it is possible to suppress the inhibition of the mounting of the cleaning liquid cartridge 323 while avoiding mixing of inks of different colors.

Next, in the embodiments of the mechanism for suppressing the erroneous mounting of the cartridge described with reference to FIG. 16 and the subsequent drawings, the control section 80 can perform the following control.

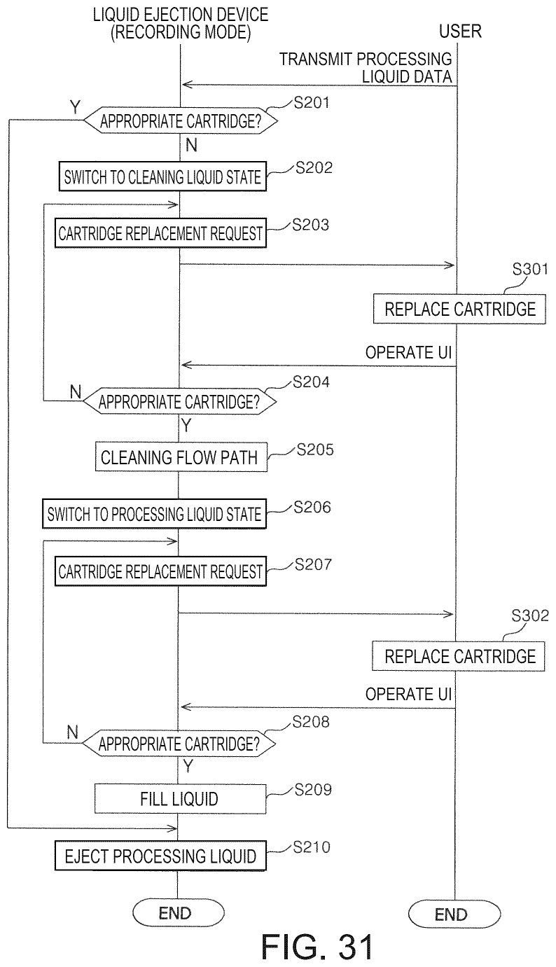

FIG. 31 is a flowchart showing an example of a relationship between the control of the control section 80 related to the mount section 200 and the user operation. Note that the liquid ejection device 1 is in the recording mode and the mount section 200 is in the recording liquid state, and a case in which the user transmits data for ejecting the processing liquid to such the liquid ejection device 1 will be described as an example.

When the user transmits to the liquid ejection device I data for ejecting the processing liquid if the mounted cartridge is appropriate for ejecting the processing liquid (Yes in step S210), the control section 80 ejects the processing liquid (step S201). Note that in the present embodiment, the liquid ejection device 1 is in the recording mode, but if the liquid ejection device 1 is in the processing liquid mode, the result is Yes in step S201, and the processing liquid is ejected (step S210).

When the mounted cartridge is not appropriate for ejecting the processing liquid (No in step S201), the control section 80 switches the mount section 200 to the cleaning liquid state (step S202). Next, the control section 80 displays a replacement request that changes to the cleaning liquid cartridge on the UI of the operation panel 86 (step S203). Note that in a configuration in which the cleaning liquid state of the above described modified example is not provided, step S202 is skipped, and in a case of No in step S201, the process proceeds to step S203.

In response to this, the user replaces the mounted cartridge with the cleaning liquid cartridge (step S301). Then, when the UI of the operation panel 86 is operated, if the mounted cartridge is the cleaning liquid cartridge (Yes in step S204), the control section 80 performs cleaning of the flow path Fr (step S205).

Note that if the mounted cartridge is not the cleaning liquid cartridge (No in step S204), the process returns to step S203.

When the cleaning of the flow path Fr is finished, the control section 80 switches the mount section 200 to the processing liquid state (step S206). Next, the control section 80 displays a replacement request that changes to the processing liquid cartridge on the UI of the operation panel 86 (step S207).

In response to this, the user replaces the mounted cartridge with the processing liquid cartridge (step S302). Then, when the UI of the operation panel 86 is operated, if the mounted cartridge is the processing liquid cartridge (Yes in step S208), the control section 80 fills the flow path Fr with the processing liquid (step S209) and then ejects processing liquid (step S210).

Note that if the cartridge mounted in step S208 is not the processing liquid cartridge (No in step S208), the process returns to step S207.

As described above, the control section 80 detects that the cleaning of the flow path Fr is completed, and it can switch from either the recording liquid state or the processing liquid state to the other.

Note that the detection of the completion of the cleaning of the flow path Fr is not limited to the case where the control section 80 executes the cleaning process (step S205), but includes, for example, a case where the user presses the “cleaning completion button” (not shown) displayed on the UI of the operation panel 86 after the user cleans himself the flow path Fr.

Note that when the control section 80 detects that the cleaning of the flow path Fr is completed, the control section 80 may switch to the standby state in which either the ink cartridge or the processing liquid cartridge can be mounted.

In the first embodiment described with reference to FIG. 17A to FIG. 17C, a position of the carriage 220 other than the first position Y1, the second position Y2, and the third position Y3, at which the cartridge can be inserted without interfering with the state forming section 340, becomes the standby state.

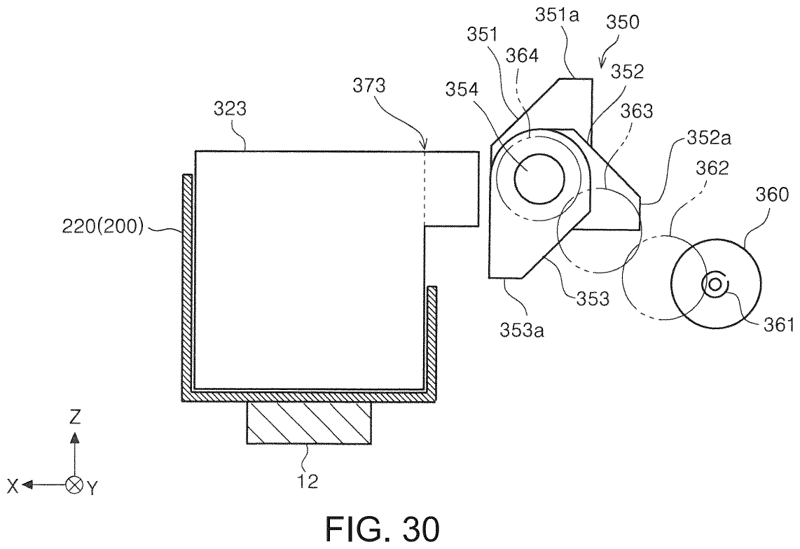

In the second embodiment described with reference to FIG. 20 and the subsequent drawings, the state shown in FIG. 30 is an example of the standby state. In this state, none of the first protrusion section 351a, the second protrusion section 352a, and the third protrusion section 353a protrude toward the mount section 200. Therefore, the cartridge can be mounted regardless of the type of the cartridge.

When either the ink cartridge or the processing liquid cartridge is mounted, the control section 80 acquires the information from the cartridge IC and can switch to either the recording liquid state or the processing liquid state based on the type of the mounted cartridge. In this case, it is not necessary for the user to input the type of the cartridge that the user himself mounted, so that usability is improved.

Note that as an example, the control section 80 can grasp the type of the mounted cartridge by acquiring the information from the cartridge IC at predetermined time intervals.

As in the case where the user operation in step S14 of FIG. 11 is the print request, the control section 80 may detect switching from either the recording mode or the processing mode to the other by receiving the print job data. In this case, the control section 80 switches to the cleaning mode (step S74 in FIG. 14, step S54 in FIG. 13), the completion of the cleaning of the flow path Fr, and then, switches from either the recording liquid state or the processing liquid state to the other.

Accordingly, it is possible to handle cases where the user transmits the job data without being aware of the current mode.

Since either the recording liquid state or the processing liquid state is switched to the other after the cleaning of the flow path Fr, it is possible to suppress that the user erroneously mounts an inappropriate type of cartridge.

The control section 80 may switch to the cleaning liquid state by detecting that the cleaning liquid cartridge is mounted on the mount section 200. Then, after the cleaning of the flow path Fr is completed, either the recording liquid state or the processing liquid state may be switched to the other.

Even in this case, there is no need for the user to instruct the user to switch the mode by the user self, and usability is improved.

Since either the recording liquid state or the processing liquid state is switched to the other after the cleaning of the flow path Fr, it is possible to suppress that the user erroneously mounts an inappropriate type of cartridge.

The control section 80 may detect the switching from either the recording mode or the processing mode to the other by the input from the operation panel 86, switch to the cleaning mode and, after the cleaning of the flow path Fr is completed, switch from either the recording liquid state or the processing liquid state to the other. Accordingly, it is possible to perform mode switching according to the user's intention.

The ink cartridge or the processing liquid cartridge described above is a cartridge that can be mounted on the mount section 200 that can be switched between the recording liquid state and the processing liquid state.

Accordingly, it is possible to suppress that the user mistakenly mounts an inappropriate cartridge. Therefore, mixing of the ink and the processing liquid can be suppressed and good results can be obtained.

When the mount section 200 has the first mount region on which the first ink cartridge containing the ink of the first color is mounted and the second mount region on which the second ink cartridge containing the ink of the second color, which is different from the first color, is mounted, any one of the black, magenta, cyan, and yellow ink cartridges is a first ink cartridge that can be mounted in the first mount region but cannot be mounted in the second mount region in the recording liquid state.

Accordingly, in a configuration in which recording can be performed with inks of different colors, mixing of inks of different colors can be avoided, and mixing of ink and the processing liquid can also be avoided.

When the mount section 200 has the first mount region on which the first ink cartridge containing the ink of the first color is mounted and the second mount region on which the second ink cartridge containing the ink of the second color different from the first color is mounted, the processing liquid cartridge is a cartridge which can be mounted on the first mount region and the second mount region in the processing liquid state.

Accordingly, more processing liquid can be ejected from the liquid ejection section 12.

The cleaning liquid cartridge 323 shown in FIG. 26 or the cleaning liquid cartridge 323 shown in FIG. 28 is a cartridge that can be mounted on the mount section 200 in the recording liquid state and the processing liquid state. According to such the cleaning liquid cartridge 323, the operation for mounting the cleaning liquid cartridge 323 is not required, and usability is improved.

The cleaning liquid cartridge 323 shown in FIG. 26 or the cleaning liquid cartridge 323 shown in FIG. 28 can be mounted on the first mount region and the second mount region in the recording liquid state and the processing liquid state. Accordingly, the degree of freedom of the pattern of the cartridge mounted on the mount section 200 is improved. For example, the ink mode (single color), the pre-processing mode, and the post-processing mode shown in FIG. 15 can be realized.

The present disclosure is not limited to the embodiments and modifications described above, various modifications are possible within the scope of the disclosure described in the claims, it is needless to say that they are also included in the scope of the present disclosure.

What is claimed is:

1. A liquid ejection device comprising:
a liquid ejection section configured to eject liquid onto a medium;
a mount section on which is mounted a liquid container containing the liquid ejected from the liquid ejection section; and
a flow path through which the liquid contained in the liquid container flows until the liquid is ejected from the liquid ejection section, wherein
the mount section is configured to alternatively have mounted thereon, as the liquid container, a recording liquid container containing a recording liquid for performing recording on the medium, and as the liquid container, a processing liquid container containing a processing liquid for performing processing on the medium and
the flow path is cleanable.

2. The liquid ejection device according to claim 1, wherein
the mount section is configured to have mounted thereon, as the liquid container, a cleaning liquid container containing a cleaning liquid for performing cleaning of the flow path.

3. The liquid ejection device according to claim 2, further comprising:
a control section configured to control the device, wherein
the control section is configured to switch between
a recording mode when recording is to be performed on the medium with the recording liquid,
a processing mode when processing is to be performed on the medium with the processing liquid, and
a cleaning mode when cleaning is to be performed on the flow path with the cleaning liquid.

4. The liquid ejection device according to claim 3, wherein
when switching from either the recording mode or the processing mode to an other mode, the control section causes interposition of cleaning of the flow path by the cleaning mode.

5. The liquid ejection device according to claim 4, wherein
the control section detects switching from either the recording mode or the processing mode to the other based on received job data and causes interposition of cleaning of the flow path in the cleaning mode.

6. The liquid ejection device according to claim 4, wherein
the control section detects mounting of the liquid container on the mount section, detects switching from either the recording mode or the processing mode to the other based on the detection, and causes interposition of cleaning of the flow path in the cleaning mode.

7. The liquid ejection device according to claim 4, wherein
the control section detects switching from either the recording mode or the processing mode to the other based on an input from an operation section that receives an operation setting and causes interposition of cleaning of the flow path in the cleaning mode.

8. The liquid ejection device according to claim 3, wherein
the recording liquid container, the processing liquid container, and the cleaning liquid container each have an information holding section that holds liquid information and that is accessible by the control section and
when power of the device is turned on, the control section accesses the information holding section and issues an alert when, compared to the liquid information when the information holding section was last accessed, one of the recording liquid container or the processing liquid container was replaced with the other.

9. The liquid ejection device according to claim 3, further comprising:
a maintenance section configured to perform maintenance of the liquid ejection section, wherein
the cleaning mode is a mode for cleaning the flow path by performing maintenance using the cleaning liquid and the maintenance section.

10. The liquid ejection device according to claim 9, further comprising:
a waste liquid storage section configured to store waste liquid generated by the maintenance section, wherein
the cleaning liquid used in the cleaning mode is discharged to the waste liquid storage section.

11. The liquid ejection device according to claim 3, wherein
during either the recording mode or the processing mode while cleaning in the cleaning mode is not completed, the control section restricts the liquid container to be used in the other mode from being mounted on the mount section.

12. The liquid ejection device according to claim 3, wherein
the mount section is configured to have mounted thereon
a first recording liquid container configured to contain recording liquid of a first color and
a second recording liquid container configured to contain recording liquid of a second color different from the first color.

13. The liquid ejection device according to claim 12, wherein
the mount section includes
a first mount region on which the first recording liquid container is mounted and
a second mount region on which the second recording liquid container is mounted and
when the processing liquid container is mounted on either the first mount region or the second mount region and when the recording liquid container is mounted on the other of the first mount region and the second mount region, the control section performs an error process.

14. The liquid ejection device according to claim 12, wherein
the mount section includes
a first mount region on which the first recording liquid container is mounted and
a second mount region on which the second recording liquid container is mounted and
when the processing mode is executed in a state where the processing liquid container is mounted on the first mount region and the cleaning liquid container is mounted on the second mount region, the control section converts image data included in the job data into data of the first color.

15. The liquid ejection device according to claim 12, wherein
the mount section includes
a first mount region on which the first recording liquid container is mounted and
a second mount region on which the second recording liquid container is mounted and
the first mount region and the second mount region are configured to have mounted thereon the processing liquid container and the cleaning liquid container.

16. The liquid ejection device according to claim 1, wherein
the liquid ejection section includes nozzles configured to eject the liquid onto the medium over an entire width direction, which intersects a transport direction of the medium.

17. A control method for a liquid ejection device,
the liquid ejection device including
a liquid ejection section configured to eject liquid onto a medium,
a mount section on which is mounted a liquid container containing the liquid ejected from the liquid ejection section, and
a flow path through which the liquid contained in the liquid container flows until the liquid is ejected from the liquid ejection section, wherein
the mount section of the liquid ejection device is configured to selectively have mounted thereon
a recording liquid container as the liquid container containing a recording liquid for performing recording on the medium,
a processing liquid container as the liquid container containing a processing liquid for performing processing on the medium, and
a cleaning liquid container as the liquid container containing a cleaning liquid for performing cleaning of the flow path,
the control method comprising:
executing a recording mode that is a mode in which recording is performed on the medium by ejecting the recording liquid from the liquid ejection section onto the medium,
executing a processing mode that is a mode in which processing is performed on the medium by ejecting the processing liquid from the liquid ejection section onto the medium, and
executing a cleaning mode that is a mode in which the flow path through which the recording liquid and the processing liquid flow are cleaned using the cleaning liquid.

18. The control method for the liquid ejection device according to claim 17, wherein the mount section includes
a first mount region on which a first recording liquid container storing recording liquid of a first color is mounted and
a second mount region on which a second recording liquid container storing recording liquid of a second color different from the first color is mounted, the control method further comprising:
determining type of the liquid container mounted on the first mount region and the second mount region and
prompting mounting of the cleaning liquid container or the processing liquid container on the second mount region when a current mode is the processing mode, the processing liquid container is mounted on the first mount region, and the recording liquid container is mounted on the second mount region.
